(19) United States
(12) Patent Application Publication
(10) Pub. No.: US 2009/0025203 A1
(43) Pub. Date: Jan. 29, 2009

(54) Method and apparatus for manufacturing laminated core and the laminated core

(75) Inventors: Naoki Tanaka, Toyohashi-shi (JP); Masayuki Nashiki, Komaki-shi (JP); Hiroyasu Kudo, Ichinomiya-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-city (JP)

(21) Appl. No.: 12/149,740

(22) Filed: May 7, 2008

(30) Foreign Application Priority Data
Jul. 26, 2007 (JP) 2007-194123

(51) Int. Cl. H02K 15/02; B23P 17/00; B23P 15/00; B23P 23/00

(52) U.S. Cl. 29/596; 29/564.1

(57) ABSTRACT

An apparatus for manufacturing a laminated stator core from core pieces according to a manufacturing method has a first station, a second station and a piling unit. The first station blanks out a steel plate to form a first hole in one core piece every blanking cycle so as to partly shape a portion of the core piece by forming the first hole. The second station blanks out the plate to form a second hole in one core piece every blanking cycle so as to partly shape the portion of the core piece by forming the second hole. Further, the first station differentiates a position of the first hole in each core piece from those in the other core pieces. Therefore, the core pieces having the respective portions are produced. The piling unit piles up the core pieces in layers to manufacture the laminated stator core.

### CROSS-REFERENCE TO RELATED APPLICATION

This application is based upon and claims the benefit of priority of the prior Japanese Patent Application 2007-194123 filed on Jul. 26, 2007 so that the contents of which are incorporated herein by reference.

### BACKGROUND OF THE INVENTION

1. Field of the Invention

The present invention relates to a method and apparatus for manufacturing a laminated core such as a stator core or a field core used in a stator or a rotor of an alternating current motor, and relates to the laminated core manufactured according to the method.

2. Description of Related Art

A stator used in an alternating current motor is composed of a laminated stator core and a winding wound around each of the magnetic pole teeth of the core. The laminated stator core is formed by piling up a predetermined number of core pieces in layers. The core pieces have the same shape, and each core piece is made of a flat rolled magnetic steel plate.

A plan view of one core piece 110 for a stator is shown in FIG. 1, and a perspective side view of a laminated stator core 120 is shown in FIG. 2. The core 120 is manufactured by piling up a plurality of core pieces 110 in layers.

As shown in FIG. 1, a core piece 110 has four magnetic pole tooth pieces 111 disposed along a circumferential direction at equal pitches. The core piece 110 has an outer circumferential surface 113. Each tooth piece 111 has an inner circumferential surface 112, a left side surface 114 and a right side surface 115. Therefore, the core 120 has four magnetic pole teeth 121, and each pole tooth 121 has an inner circumferential surface 122, a left side surface 123 and a right side surface 124.

FIG. 3 is a side view schematically showing an apparatus 130 for manufacturing the core 120.

As shown in FIG. 3, the apparatus 130 has an upper die 140, a lower die 150 and guide posts 160. Each post 160 connects the dies 140 and 150 such that the die 140 is slidable on the post 160 so as to lift the die 140 up and down on the die 150. The apparatus 130 is partitioned into a first station S101, a second station S102 and a third station S103. The apparatus 130 performs a press blanking operation In each of the stations S101 to S103 for a flat rolled magnetic steel plate 170 moved on the die 150 from the first station S101 to the third station S103. When the die 140 is repeatedly lifted up and down to blank out portions of the plate 170, a plurality of core pieces 110 shown in FIG. 1 are produced one after another. Then, a predetermined number of core pieces 110 are piled up in an axial direction of the piece 110 and are bound together. Therefore, the laminated stator core 120 shown in FIG. 2 is manufactured. As shown in FIG. 2, each of the surfaces 122, 123 and 124 in the core 120 is formed to be parallel to the axial direction.

A method for manufacturing the core 120 is described below. FIG. 4 is a plan view of the lower die 150, and FIG. 5 is a plan view of the steel plate 170 blanked out in each of the stations of the apparatus 130. In FIG. 5, a solid line indicates a cutting line of the plate 170 actually cut in the press blanking operation, and a dotted line indicates a cutting line of the plate 170 not yet cut in the press blanking operation. The plate 170 is blanked out in the left, middle and right figures shown in FIG. 5 in the respective station S101 to S103.

As shown in FIG. 4, on the lower die 150, there are a die 151 disposed in the station S101, a die 152 disposed in the station S102 and a die 153 disposed in the station S103. In response to each lifting up and down of the upper die 140, one press blanking operation is performed in each of the stations. That is, the side surfaces 114 and 115 of each tooth piece 111 are formed on the plate 170 in the station S101 (see the left side of FIG. 5), the surfaces 112 of the tooth piece 111 are formed on the plate 170 in the station S102 (see the middle side of FIG. 5), and the surface 113 of the core piece 110 is formed on the plate 170 in the station S103 (see the right side of FIG. 5) so as to cut off one core piece 110 from the plate 170. Then, a predetermined number of core pieces 110 are piled up in an open space of the die 150 placed in the station S103 as one laminated stator core 120. Each of the surfaces 122 to 124 of the teeth 121 in this core 120 extends in parallel to the axial direction. A tooth width W₁₁₁ between two teeth 121 in each pair is set to a fixed value only by one press blanking operation in the station S101. The width W₁₁₁ is equal to the distance between the surfaces 114 and 115 across one tooth piece 111. After the formation of the surfaces 114 and 115 setting the tooth width, the surfaces 112 are formed in the station S102, and the surfaces 113 are formed in the station S103.

As another prior art, a laminated stator core having a skew has been proposed in each of Published Japanese Patent First Publication No. H08-223829 and Published Japanese Patent First Publication No. 2004-242420. FIG. 6 is a perspective side view of a laminated stator core having a skew. As shown in FIG. 6, to manufacture a laminated stator core 180, a predetermined number of core pieces 190 having the same shape are produced, and the core pieces 190 are piled up in layers in the axial direction of the core piece 190. In this piling operation, each core piece 190 is shifted along its circumferential direction each time the core piece 190 is piled on another core piece 190. Therefore, a center axis of each magnetic pole tooth 191 in the stator core 180 is inclined toward the circumferential direction with respect to a center axis of the stator core 180 parallel to the axial direction. When a winding is wound around each tooth 191 of the core 180, a stator for a motor is obtained. Because of the skew in the stator core 180, torque ripple and cogging torque caused in the motor can be reduced.

However, in the apparatus for manufacturing the laminated stator core according to the prior art, the core pieces piled up are required to have the tooth pieces set in the same shape and size. Therefore, the shape of each tooth in the stator core manufactured in the apparatus cannot be arbitrarily set. To solve this problem, there is an idea that a laminated stator core is formed by piling up core pieces each of which has tooth pieces having different shapes from those of the other core pieces. However, to manufacture a laminated stator core by piling up the core pieces having different shaped tooth pieces, a manufacturing apparatus is required to have a plurality of metal dies of which the number is equal to the number of different shapes of the tooth pieces. Therefore, in the manufacturing apparatus according to the prior art, laminated stator cores are manufactured with low productivity and at high cost. Further, a large sized manufacturing apparatus is required in order to use the large number of dies corresponding to different shapes of the tooth pieces.

### SUMMARY OF THE INVENTION

An object of the present invention is to provide, with due consideration to the drawbacks of the conventional manufacturing method and apparatus, a laminated core manufacturing method and apparatus wherein a laminated core having an arbitrary shape is efficiently manufactured at low cost.

Further, the object of the present invention is to provide a laminated core manufactured according to this method.

According to an aspect of this invention, the object is achieved by the provision of a method for manufacturing a laminated core from a plurality of core pieces, comprising a step of blanking out a first portion of a steel plate every blanking cycle to form a first hole of one core piece in the steel plate every blanking cycle, a step of blanking out a second portion of the steel plate every blanking cycle to form a second hole of one core piece in the steel plate every blanking cycle, a step of producing the core pieces from the steel plate in a plurality of blanking cycles, and a step of piling up the produced core pieces in layers to manufacture the laminated core. The step of blanking out the first portion includes partly shaping a portion of each core piece by forming the first hole of the core piece, and differentiating a position of the first hole in a particular core piece among the core pieces from positions of the first holes in the other core pieces. The step of blanking out the second portion includes partly shaping the portion of each core piece by forming the second hole of the core piece to shape the portion of the core piece by forming the first and second holes.

The object is also achieved by the provision of a laminated core manufactured according to this manufacturing method.

In this method and the laminated core, to produce each core piece having a portion, a first hole of the core piece is formed in the steel plate in one blanking operation, and a second hole of the core piece is formed in the steel plate in one blanking operation. Therefore, the portion of the core piece is shaped by forming the first and second holes. When a particular core piece is produced, a position of the first hole is differentiated from those in the other core pieces to differentiate a shape of the particular core piece from those of the other core pieces. Therefore, a shape of one core piece forming one layer in the laminated core can be changed as desired.

Accordingly, because each of the core pieces required to manufacture one laminated core can be arbitrarily shaped only in two blanking operations of respective blanking stations, the laminated core having an arbitrary shape can be efficiently manufactured at low cost.

It is preferred that a position of the second hole in the particular core piece be differentiated from positions of the second holes in the other core pieces.

In this preferred method, a center of the portion in the particular core piece can be aligned with those in the other core pieces along a piling direction of the laminated core. Therefore, the core pieces can be piled up without adjusting a position of the particular core piece. Accordingly, the laminated core having an arbitrary shape can be further efficiently manufactured at a lower cost.

The object is also achieved by the provision of an apparatus for manufacturing a laminated core from a plurality of core pieces, comprising a first blanking station that blanks out a first portion of a steel plate every blanking cycle to form a first hole of one core piece in the steel plate every blanking cycle, a second blanking station that blanks out a second portion of the steel plate every blanking cycle to form a second hole of one core piece in the steel plate every blanking cycle, and a piling unit that produces the core pieces from the steel plate in a plurality of blanking cycles and piles up the core pieces in layers to manufacture the laminated core. The first blanking station partly shapes a portion of each core piece by forming the first hole of the core piece while differentiating a position of the first hole in a particular core piece among the core pieces from positions of the first holes in the other core pieces. The second blanking station partly shapes the portion of each core piece by forming the second hole of the core piece such that the portion of the core piece is shaped by forming the first and second holes.

With this structure of the apparatus, the manufacturing of the laminated core according to the manufacturing method can be realized. Accordingly, the laminated core having an arbitrary shape can be efficiently manufactured at a lower cost.

### BRIEF DESCRIPTION OF THE DRAWINGS

FIG. 1 is a plan view of a core piece in the prior art;

FIG. 2 is a perspective side view of a laminated stator core manufactured from core pieces shown in FIG. 1;

FIG. 3 is a side view schematically showing an apparatus for manufacturing the stator core shown in FIG. 2 according to the prior art;

FIG. 4 is a plan view of a lower die of the apparatus shown in FIG. 3;

FIG. 5 is a plan view of a steel plate blanked out by the apparatus shown in FIG. 3;

FIG. 6 is a perspective side view of a laminated stator core having a skew in the prior art;

FIG. 7 is a side view of an apparatus for manufacturing a laminated stator core according to the first embodiment of the present invention;

FIG. 8 is a perspective side view of a laminated stator core manufactured in the apparatus shown in FIG. 7;

FIG. 9 is a plan view of three representative types of core pieces finally produced in the apparatus shown in FIG. 7;

FIG. 10 is a view of inner circumferential walls of respective magnetic pole teeth spread out along the circumferential direction in the core shown in FIG. 8;

FIG. 11 is a plan view of a lower die of the apparatus shown in FIG. 7;

FIG. 12 is a side view of a first station of the apparatus shown in FIG. 7;

FIG. 13 is a side view of a second station of the apparatus shown in FIG. 7;

FIG. 14 is a side view of a fourth station of the apparatus shown in FIG. 7;

FIG. 15 is a plan view of both a lower die including a die holder not yet rotated and a lower die including a die holder rotated;

FIG. 16 is a plan view of a steel plate blanked out to form a part of one core piece in each of stations;

FIG. 17 is a flow chart showing the procedure in the manufacturing of a laminated stator core performed in the apparatus shown in FIG. 7;

FIG. 18 shows the relationship between the number of produced core pieces and the total rotation angle of holders in the first station according to the first embodiment;

FIG. 19 is a plan view of a lower die of an apparatus according to the second embodiment of the present invention;

FIG. 20A is a plan view of die holders of first and second stations before a rotation of each die holder;

FIG. 20B is a plan view of the die holders of the first and second stations after a rotation of each die holder;

FIG. 21 is a plan view of the plate blanked out to partially form one core piece in each of stations;

FIG. 22A shows the relationship between the number of produced core pieces and the total rotation angle in the first station according to the second embodiment;

FIG. 22B shows the relationship between the number of produced core pieces and the total rotation angle in the second station according to the second embodiment;

FIG. 23 is a plan view of three representative types of core pieces finally produced in the apparatus shown in FIG. 19;

FIG. 24 is a view of inner circumferential walls spread out along the circumferential direction in a laminated stator core manufactured according to a first modification based on the first embodiment;

FIG. 25 shows the relationship between the number of produced core pieces and the total rotation angle in the first station according to the first modification;

FIG. 26 is a view of inner circumferential walls spread out along the circumferential direction in a laminated stator core manufactured according to a second modification based on the first embodiment;

FIG. 27 shows the relationship between the number of produced core pieces and the total rotation angle in the first station according to the second modification;

FIG. 28 is a perspective side view of a laminated stator core according to a third modification based on the second embodiment;

FIG. 29 is a plan view of three representative types of core pieces produced according to the third modification;

FIG. 30 is a view of inner circumferential walls of respective magnetic pole teeth spread out along the circumferential direction in the stator core shown in FIG. 28;

FIG. 31 is a plan view of both a set of die holders not yet rotated and a set of die holders rotated according to the third modification;

FIG. 32A shows the relationship between the number of produced core pieces and the total rotation angle in the first station according to the third modification;

FIG. 32B shows the relationship between the number of produced core pieces and the total rotation angle in the second station according to the third modification;

FIG. 33 is a view of inner circumferential walls of magnetic pole teeth spread out along the circumferential direction in a laminated stator core manufactured according to a fourth modification based on the second embodiment;

FIG. 34A shows the relationship between the number of produced core pieces and the total rotation angle in the first station according to the fourth modification;

FIG. 34B shows the relationship between the number of produced core pieces and the total rotation angle in the second station according to the fourth modification;

FIG. 35 is a perspective side view of a laminated stator core according to a fifth modification based on the second embodiment;

FIG. 36 is a plan view of three representative types of core pieces produced according to the fifth modification;

FIG. 37 is a view of inner circumferential walls of respective magnetic pole teeth spread out along the circumferential direction in a stator core shown in FIG. 35;

FIG. 38 is a plan view of both a set of die holders not yet rotated and a set of die holders rotated according to the fifth modification;

FIG. 39A shows the relationship between the number of produced core pieces and the total rotation angle in the first station according to the fifth modification;

FIG. 39B shows the relationship between the number of produced core pieces and the total rotation angle in the second station according to the fifth modification;

FIG. 40 is a view of inner circumferential walls of magnetic pole teeth spread out along the circumferential direction in a laminated stator core manufactured according to a sixth modification based on the second embodiment;

FIG. 41A shows the relationship between the number of produced core pieces and the total rotation angle in the first station according to the sixth modification; and

FIG. 41B shows the relationship between the number of produced core pieces and the total rotation angle in the second station according to the sixth modification.

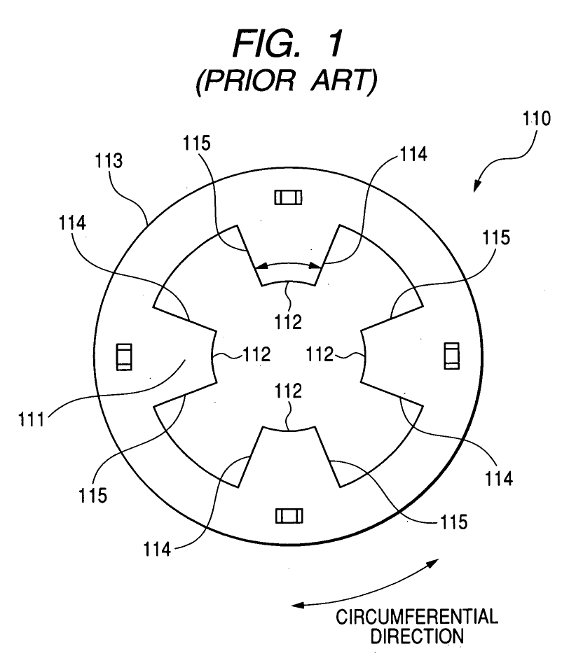

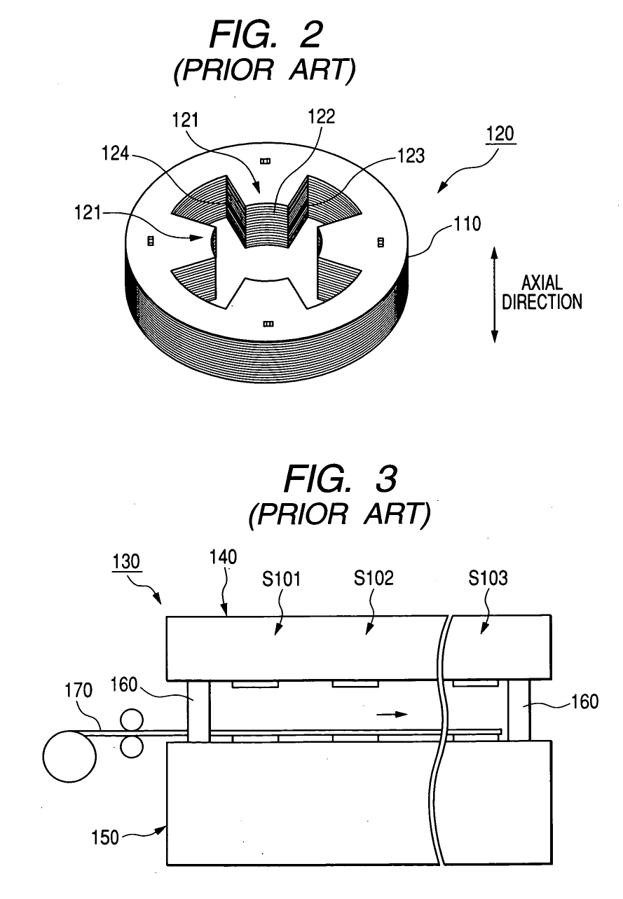

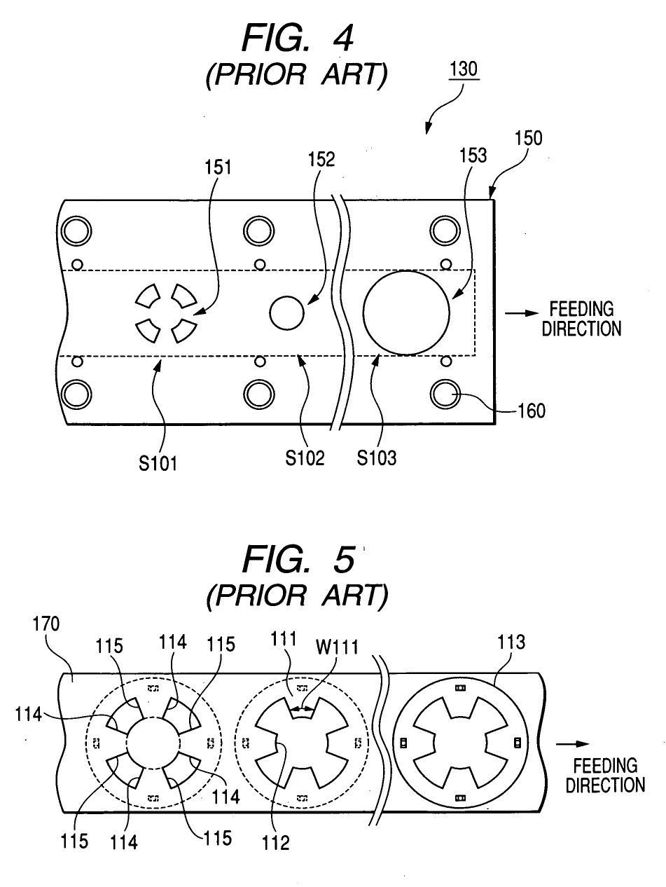

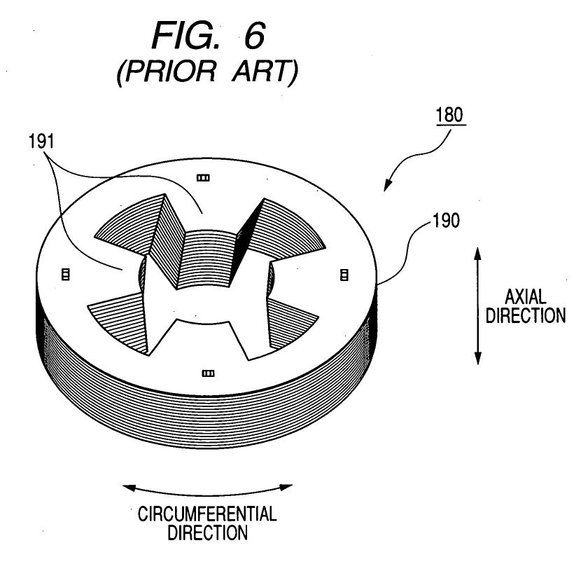

### DETAILED DESCRIPTION OF THE PREFERRED EMBODIMENTS

A method and apparatus for manufacturing a laminated stator core from a plurality of core pieces are described according to each of embodiments. In this method and apparatus, a first blanking station blanks out a portion of a steel plate every blanking cycle to form a first hole in one core piece every blanking cycle and to partly shape a portion of the core piece by forming the first hole, and a second blanking station blanks out another portion of the plate every blanking cycle to form a second hole in one core piece every blanking cycle and to partly shape the portion of the core piece by forming the second hole. Therefore, the core pieces are produced. Then, a piling up unit piles up the core pieces in layers to manufacture the laminated stator core. Further, the first blanking station differentiates a position of the first hole in a particular core piece among the core pieces from those in the other core pieces.

The apparatus may place the second hole in each core piece at a fixed position. Further, the apparatus may differentiate a position of the second hole in the particular core piece from those in the other core pieces.

An example of the apparatus and method according to each of embodiments of the present invention will now be described with reference to the accompanying drawings.

### Embodiment 1

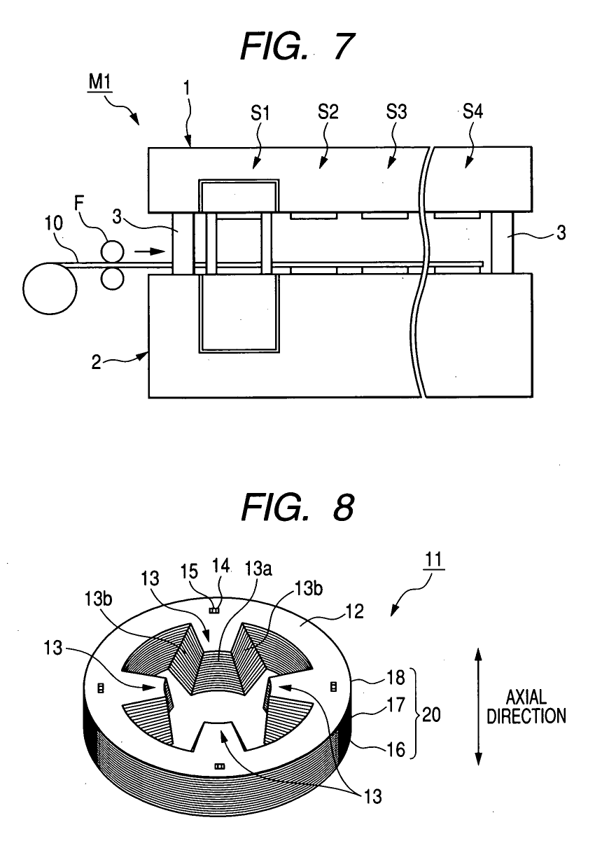

FIG. 7 is a side view of an apparatus for manufacturing a laminated stator core according to the first embodiment.

As shown in FIG. 7, an apparatus M1 has an upper die 1, a lower die 2 and guide posts 3. Each post 3 connects the dies 1 and 2 so as to permit a relative motion of the dies 1 and 2. That is, the die 1 is slidably moved on the posts 3 to be lifted up and down on the die 2. A combination of the dies 1 and 2 is partitioned into regions of a plurality of press blanking stations containing a first station S1, a second station S2, a third station S3, stations (not shown) and a fourth station S4 located at equal intervals in that order. A flat rolled magnetic steel plate 10 is fed by a feeding member (i.e., roller) F along a feeding direction from the first station S1 to the fourth station S4. Each time the die 1 is lifted up and down, the plate 10 is fed by a length corresponding to the interval between stations, and the apparatus M1 performs a press blanking operation for the plate 10 in each station to produce a core piece from each portion of the plate 10. The apparatus M1 piles up a predetermined number of core pieces in layers and binds the core pieces with one another to manufacture a laminated stator core.

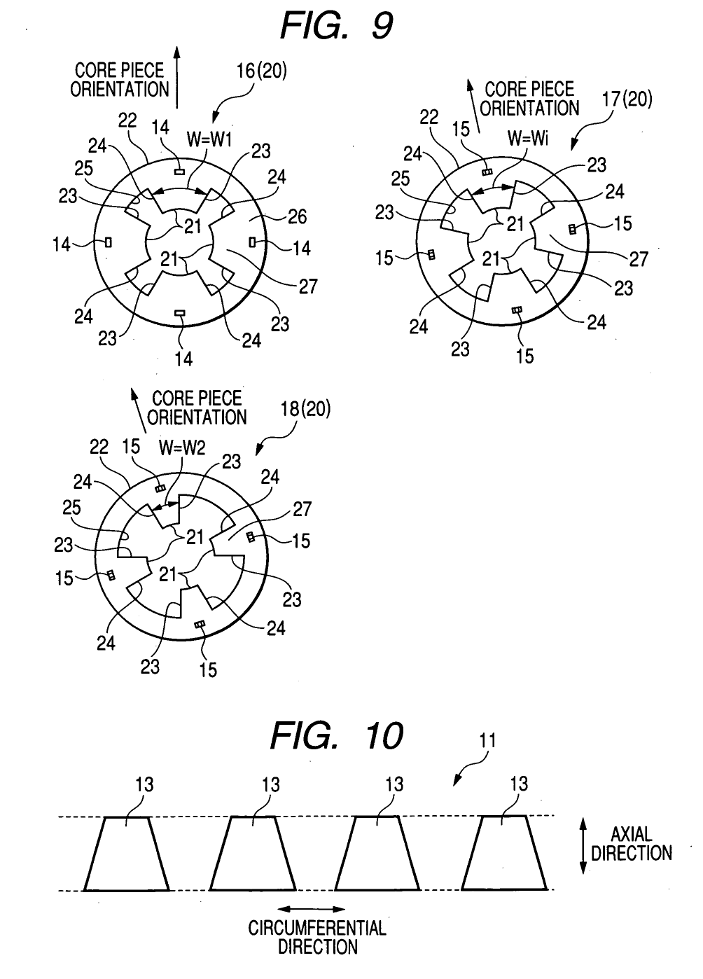

FIG. 8 is a perspective side view of a laminated stator core manufactured in the apparatus M1. FIG. 9 is a plan view of three representative types of core pieces produced in the apparatus M1. FIG. 10 is a view of inner circumferential walls of respective magnetic pole teeth of the stator core spread out along the circumferential direction.

As shown in FIG. 8, a laminated stator core 11 manufactured in the apparatus M1 is obtained by piling up a predetermined number of core pieces 20 (see FIG. 9) along an axial direction (i.e., piling direction) of the core 11. The stator core 11 is formed in a disc shape having a hollow in the center of the core 11. The stator core 11 has a ring portion 12 and four magnetic pole teeth 13 disposed along a circumferential direction (i.e., rotational direction) of the core 11 at equal intervals. The teeth 13 are substantially formed in the same shape, and each tooth 13 is projected into the hollow along a radial direction of the core 11. Each tooth 13 has an inner circumferential wall 13a and two side walls 13b. Each wall 13a is formed in a trapezoidal shape and extends along the axial direction while being slightly curved along the circumferential direction. Each side wall 13b is formed in a rectangular shape and is inclined with respect to the axial direction. Therefore, each tooth 13 is substantially formed in a frustum of pyramid. The walls 13a of the teeth 13 face one another.

As shown in FIG. 9, the core pieces 20 are represented by a type of core piece 16 forming the lowermost layer of the core 11, a type of core piece 17 forming each of middle layers, and a type of core piece 18 forming the uppermost layer. Each core piece 20 has a ring portion 26 and four magnetic pole tooth portions 27. A lamination of portions 27 forms one magnetic pole tooth 13 of the core 11. Each tooth portion 27 has an inner circumferential surface 21, a left side surface 23 and a right side surface 24. The ring portion 26 has an outer circumferential surface 22 and other inner circumferential surfaces 25.

The core pieces 20 may have binding portions to bind the core pieces 20 to one another. For example, as shown in FIG. 9, the core piece 16 has four through holes 14 for binding, each core piece 17 has four projections 15 for binding, and the core piece 18 has four projections 15 for binding. Each of the holes 14 and projections 15 is disposed in the portion 26 so as to be placed in the middle of one portion 27 along the circumferential direction. Each projection 15 projects toward a lower layer of the core 11 so as to have a hollow. Therefore, an upper core piece 20 and a lower core piece 20 facing each other in each pair can be piled up such that each projection 15 of the upper core piece 20 is received in the corresponding hollow or hole 14 of the lower core piece 20.

In each core piece 20, the tooth portions 27 have the same width W along the circumferential direction of the core piece 20. The width W denotes an interval between the surfaces 23 and 24 through one tooth portion 27. In contrast, the core pieces 20 have different shapes to one another such that the width W in each core piece 20 is narrower than the width W in another core piece 20 on which the core piece 20 is piled. That is, as the core piece 20 is located at an upper layer, the width W in the core piece 20 is gradually narrowed. The core piece 16 has the maximum width W1, and the core piece 18 has the minimum width W2. The core pieces 17 have the widths Wi (W1>Wi>W2, i=3, 4, - - - , n). Therefore, as shown in FIG. 8 and FIG. 10, when each tooth 13 of the core 11 is seen from the center axis of the core 11, the tooth 13 has a wall 13a shaped in a trapezoid. Because of the trapezoidal teeth 13, torque ripple and cogging torque caused in a motor with the core 11 can be reduced, in the same manner as in a motor using a stator core with skew.

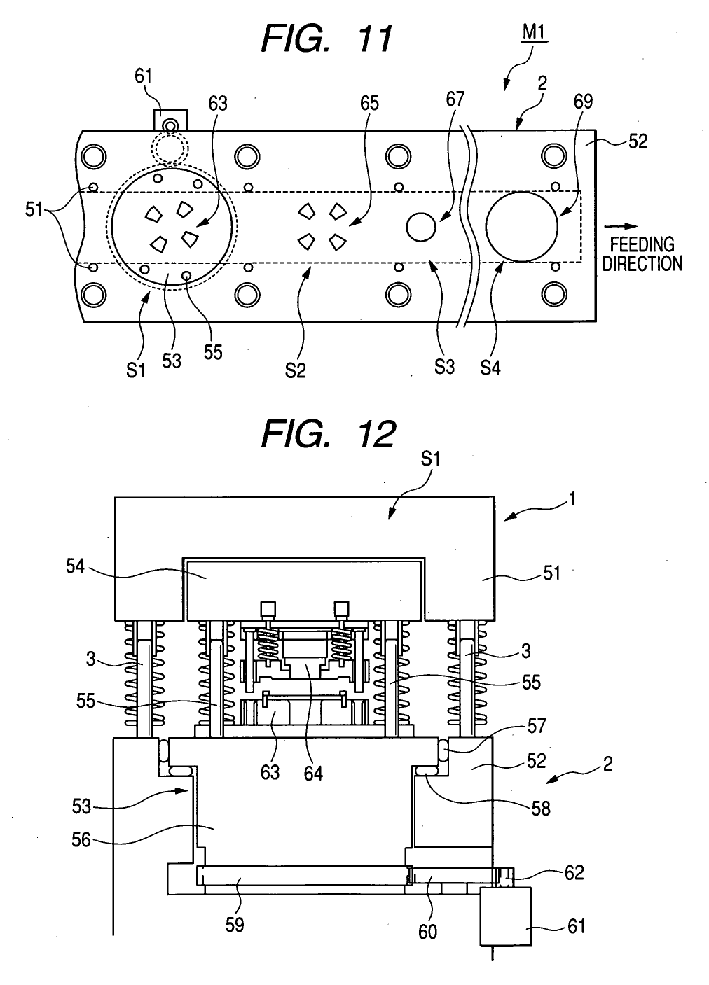

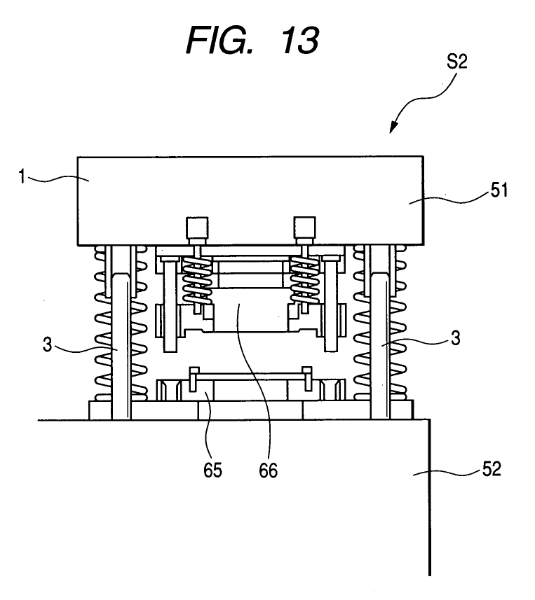

The structure of the apparatus M1 is described with reference to FIG. 11 to FIG. 14. FIG. 11 is a plan view of the lower die 2 of the apparatus M1. FIG. 12 is a side view of the first station S1 seen from a side of the member F after removal of members covering the first station S1. FIG. 13 is a side view of the second station S2 seen from a side of the member F after removal of members covering the second station S2. FIG. 14 is a side view of the fourth station S4 seen from a side of the member F after removal of members covering the fourth station S4. In FIG. 11, for convenience of explanation, stations for forming a pilot hole, holes 14 and projections 15 of core pieces 20 are omitted.

As shown in FIG. 11 and FIG. 12, the upper die 1 of the apparatus M1 has an upper die frame 51 and a punch holder 54. The die 2 of the apparatus M1 has a lower die frame 52 and a die holder 53. The die frame 51 holds punches of the stations S2 to S4. The die frame 52 holds dies of the stations S2 to S4. The holders 53 and 54 are disposed in the first station S1. In the first station S1, guide posts 55 fixedly stand on the holder 53, and the holder 54 is slidable on the posts 55. Therefore, the holder 54 is slidably lifted up and down on the holder 53. The holders 53 and 54 are disposed to be movable on the respective frames 51 and 52.

In the first station S1, the apparatus M1 forms the surfaces 23 and parts of the surfaces 25 of each core piece 20 on the plate 10. To form the surfaces 23 and 25, a die 63 is fixedly disposed on the holder 53, and a punch 64 paired with the die 63 is fixedly disposed on the holder 54 at a position just above the die 63. As shown in FIG. 11, the die 63 has four rectangular holes aligned along a circular line at equal pitches, and each hole is formed in an arc shape. The punch 64 has four projections fitting to the respective holes of the die 63. The width of each projection of the punch 64 (or width of each hole of holder 53) along a circumferential direction of a circle defined by the projections is set to be equal to or larger than a half of the length of each surface 25 of the core piece 18 along the circumferential direction of the piece 18 and to be equal to or smaller than the length of each surface 25 of the core piece 16 along the circumferential direction of the piece 16. Further, the length of each projection of the punch 64 (or length of each hole of holder 53) along a radial direction of a circle formed by the projections is substantially equal to a projection length of each tooth portion 27 of the core piece 20.

Further, the apparatus M1 has a rotation mechanism for rotating a unit of the holders 53 and 54 so as to rotate the die 63 and the punch 64 by a predetermined rotation angle in the horizontal plane, relative to the plate 10. As the rotation mechanism of the first station S1, the holder 53 has a base 56 supported by the frame 52 through a radial bearing 57 and a thrust bearing 58. Further, the holder 53 has a driven gear 59 fixed to the base 56, a servo motor 61, a driving gear 62 attached to an output shaft of the motor 61, and an idle gear 60 meshing with the gears 59 and 62. Therefore, when the motor 61 receives an input signal from an operator through a control unit, the driving gear 62 is rotated by a certain angle, the rotational force of the gear 62 is transmitted to the driven gear 59 through the idle gear 60, and the base 56 is rotated by a predetermined rotation angle each time the holder 54 is lifted up and down. Therefore, the die 63 and the punch 64 disposed on the holders 53 and 54 can be rotated with the base 56 so as to differentiate positions of the surfaces 23 of each core piece 20 from those of the other core pieces 20. That is, the first station S1 is rotationally movable. Because relative positions of the holders 53 and 54 to each other on a horizontal plane are always fixed by the posts 55, the relative positions of the die 63 and the punch 64 are fixed even when the die 63 and the punch 64 are rotated on the plate 10.

Therefore, in the first station S1, the apparatus M1 can blank out a portion of the plate 10 by the die 63 and the punch 64 every press blanking operation to form the surfaces 23 and parts of the surfaces 25 at changeable positions of one core piece 20. That is, positions of the surfaces 23 of each core piece 20 can be differentiated from those of the surfaces 23 of the other core pieces 20.

As shown in FIG. 11 and FIG. 13, in the second station S2, the apparatus M1 forms the surfaces 24 and the other parts of the surfaces 25 of each core piece 20. That is, the posts 3 fixedly stand on the frame 52 of the lower die 2, and the frame 51 of the upper die 1 is slidable on the posts 3. Therefore, the frame 51 is slidably lifted up and down on the frame 52. A die 65 is fixed to the frame 52, and a punch 66 paired with the die 65 is fixed to the frame 51 at a position just above the die 65. The die 65 has four rectangular holes aligned along a circular line at equal pitches, and each hole is formed in an arc shape. Each hole of the die 65 is substantially the same shape and size as that of the die 63. The punch 66 has four projections fitting to the respective holes of the die 65. The size and shape of the die 65 are substantially the same as those of the die 63. Positions of the die 65 and the punch 66 in the horizontal plane are fixed, so that the second station S2 acts as a fixed station.

Therefore, in the second station S2, the apparatus M1 can blank out a portion of the plate 10 by the die 65 and the punch 66 every press blanking operation to form the surfaces 24 and the other parts of the surfaces 25 of one core piece 20 at fixed positions of the core piece 20. That is, the surfaces 24 in each core piece 20 can be placed at the same positions as positions of the surfaces 24 in the other core pieces 20. Therefore, in the stations S1 and S2, the apparatus M1 can form the surfaces 23, 24 and 25 of each core piece 20 while setting a distance between the surfaces 23 and 24 facing each other at a changeable value every press blanking operation.

As shown in FIG. 11, in the third station S3, a die 67 is fixed to the frame 52 of the lower die 2, and a punch paired with the die 67 is fixedly disposed on the frame 51 of the upper die 1 at a position just above the die 67. The die 67 has a circular hole substantially having the same diameter as that of a circle shaped by the surfaces 21 of each core piece 20.

Therefore, in the third station S3, the apparatus M1 can blank out a portion of the plate 10 by the die 67 and the punch paired with the die 67 every press blanking operation to form the surfaces 21 of one core piece 20 at a fixed position of the core piece 20. The structure of the third station S3 is the same as that of the second station S2, so that a figure showing the structure of the third station S3 is omitted.

As shown in FIG. 11 and FIG. 14, in the fourth station S4, the apparatus M1 forms the surface 22 of each core piece 20 to produce a blank from the plate 10 as the core piece 20. A punch 70 is fixedly disposed on the frame 51, and a die 69 paired with the punch 70 is fixedly disposed on the frame 52 at a position just under the punch 70. Each of the punch 70 and the die 69 is substantially shaped in a circle set at the same diameter as the external diameter of the core piece 20.

Therefore, in the fourth station S4, the apparatus M1 can blank out a portion of the plate 10 by the die 69 and the punch 70 every press blanking operation to form the surface 22 of one core piece 20 at a fixed position of the core piece 20 and to drop the core piece 20 through the die 69.

The frame 52 has a core piece holding space 52a vertically extending just under the die 69 and a laminated core discharging space 52b horizontally extending and communicating with the space 52a. In the space 52a, a driving member 72 lifts up and down a cylinder 71 just under the die 69. Each time one core piece 20 is produced in the fourth station S4, the core piece 20 is dropped onto the cylinder 71. Each time the cylinder 71 received one core piece 20, the member 72 lifts down the cylinder 71 by a predetermined length. Therefore, a predetermined number of core pieces 20 can be mounted on the cylinder 71.

Further, because of the rotation of only the first station S1, the positions of the walls 23 in each core piece 20 are differentiated from those in the other core pieces 20, while the positions of the walls 24 in the respective core piece 20 are the same. Therefore, as shown in FIG. 9, in each core piece 20 just produced in the fourth station S4, a core piece orientation from a center of the core piece 20 to a center of one tooth portion 27 of the core piece 20 is differentiated from those in the other core pieces 20. To align centers of the tooth portions 27 of the core pieces 20 in the axial direction, the member 72 acts as a rotation member to rotate the cylinder 71 by a predetermined rotation angle each time one core piece 20 is dropped onto the cylinder 71. Therefore, the core pieces 20 are assembled into one laminated stator core 11 on the cylinder 71 such that the teeth 13 in the core 11 have respective trapezoidal walls 13a facing one another.

After the assembling of the stator core 11, the cylinder 71 is dropped down to place the stator core 11 in the space 52b, and a pushing member 73 disposed in the space 52b pushes the stator core 11 outside the apparatus M1 through an opening 52c.

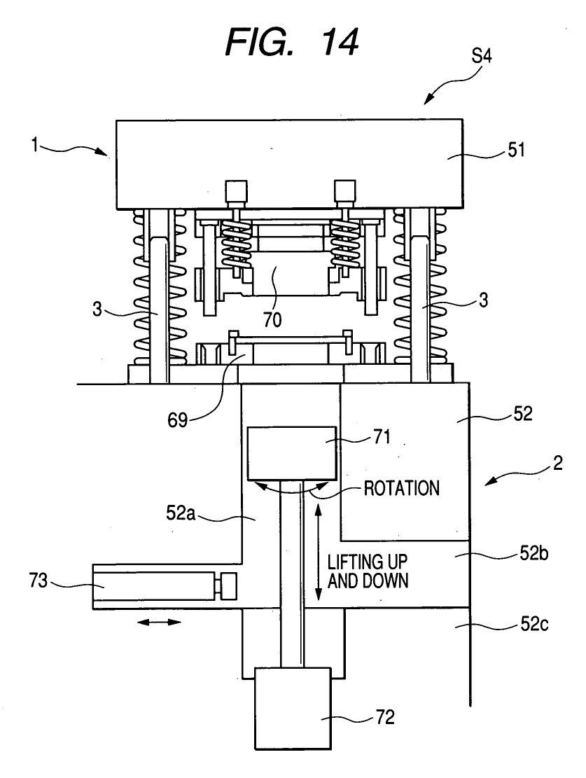

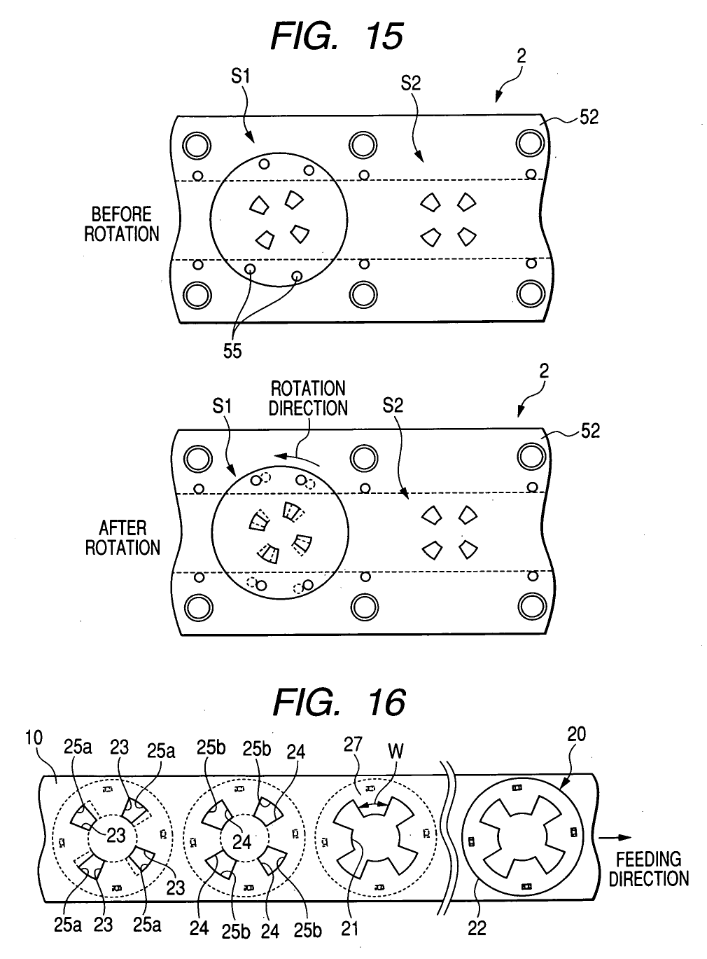

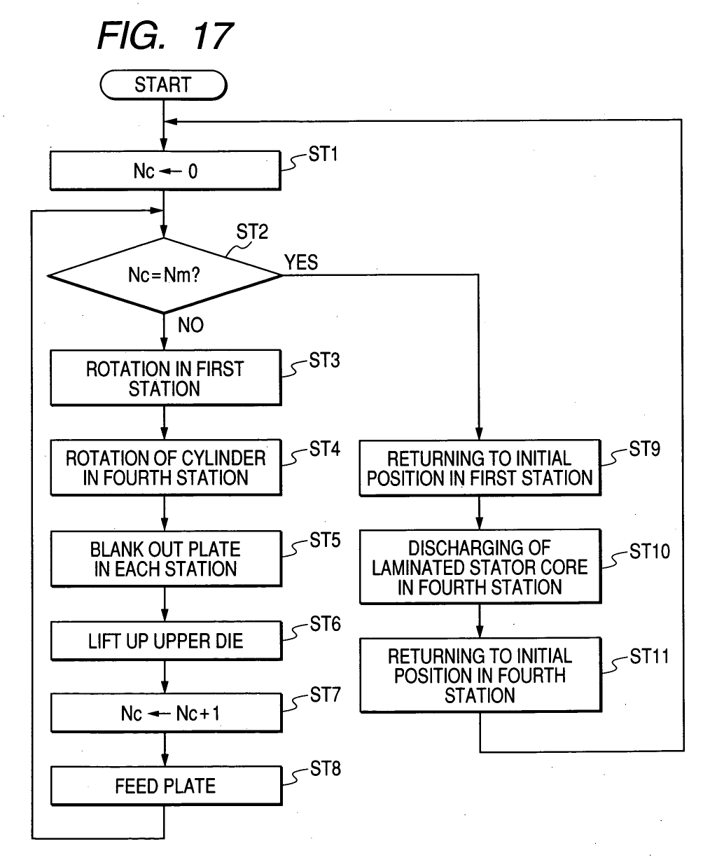

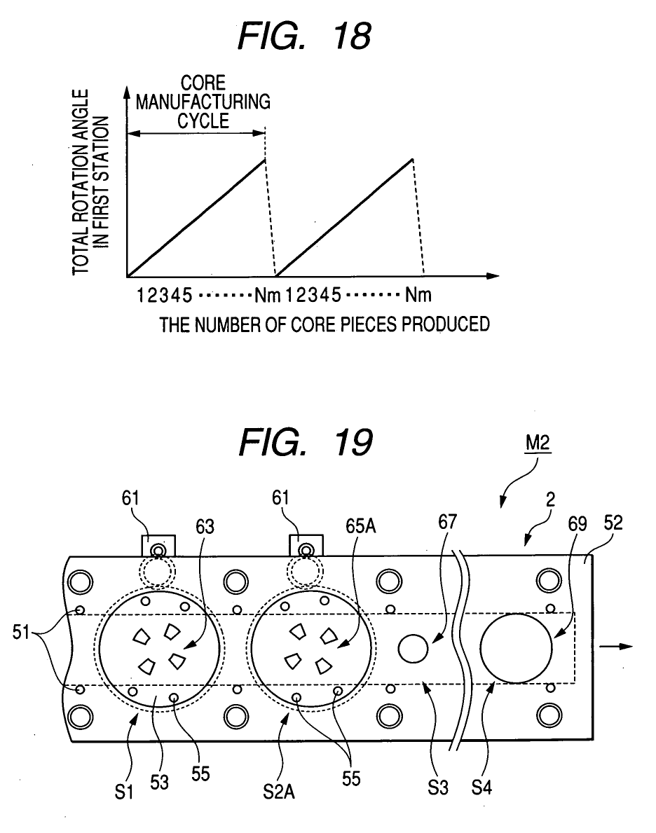

Next, an operation of the apparatus M1 is described. FIG. 15 is a plan view of both the die holder 53 not yet rotated and the die holder 53 rotated. FIG. 16 is a plan view of the plate 10 blanked out to form a portion of one core piece 20 in each of the stations S1 to S4. In FIG. 16, a solid line indicates a cutting line of the plate 10 actually cut, and a dotted line indicates a cutting line of the plate 10 planned to be cut. FIG. 17 is a flow chart showing the procedure in the manufacturing of a laminated stator core performed in the apparatus M1. FIG. 18 shows the relationship between the number of produced core pieces 20 and the total rotation angle of holders in the first station S1.

The apparatus M1 feeds the plate 10 wound in a roll to the stations S1 to S4 in that order by using the feeding member F. Therefore, as shown in FIG. 16, each core piece 20 is partially shaped in the plate 10 in each of the stations S1 to S4. The apparatus M1 has a control unit (not shown). The apparatus M1 performs a press blanking operation in each of the stations S1 to S4 under control of the control unit every press blanking cycle to produce one core piece 20. The apparatus M1 manufactures one laminated stator core 11 from a predetermined number of produced core pieces 20 every core manufacturing cycle.

The procedure in the manufacturing of the core 11 is described with reference to FIG. 17. The plate 10 is moving on the lower die 2 along a feeding direction from the first station S1 to the fourth station S4.

At step ST1, a count number Nc is initially set at zero. The number Nc indicates the number of core pieces 20 produced in the apparatus M1 every core manufacturing cycle. Therefore, the number Nc is increased by one every press blanking cycle and is reset at zero every core manufacturing cycle.

At step ST2, it is judged whether or not the number Nc is equal to a maximum core piece number Nm. The number Nm is set at the number of core pieces 20 required to obtain one laminated stator core 11.

When the number Nc differs from the number Nm, the procedure proceeds to step ST3. At step ST3, in the first station S1, a combination of holders 53 and 54 seen from the upper side is rotated counterclockwise, so that the set of die 63 and punch 64 is rotated by a first rotation angle θ₁. Therefore, as shown in FIG. 15, the relative position of the set of die 63 and punch 64 to the plate 10 is shifted along a circumferential direction of a circle defined by the holes of the die 63 or the projections of the punch 64.

At step ST4, in the fourth station S4, the cylinder 71 seen from the upper side is rotated counterclockwise by a second rotation angle θ₂ (θ₂=0.5×θ₁). Further, the cylinder 71 is dropped down by the thickness of the plate 10.

At step ST5, the upper die 1 is pressed down, so that the steel plate 10 is blanked out in each of the stations S1 to S4. Further, one core piece 20 newly produced in the fourth station S4 is dropped and piled up on the cylinder 71. Because the cylinder 71 is rotated counterclockwise at step ST4, the newly produced core piece 20 is shifted in the clockwise direction on the cylinder 71 as compared with another core piece 20 piled on the cylinder 71 just before the newly produced core piece 20.

At step ST6, the upper die 1 is lifted up.

At step ST7, because one press blanking operation has been performed in each station at step ST5 to produce one core piece 20, the number Nc is increased by one.

At step ST8, the plate 10 is fed by the required length between stations. Then, the procedure returns to step ST2. Therefore, one press blanking cycle is completed. This blanking cycle is repeatedly performed until the number Nc becomes equal to the number Nm at step ST2. Therefore, as shown in FIG. 18, the total rotation angle of holders in the first station S1 is increased by the angle θ₁ every press blanking cycle.

When the number Nc is equal to the number Nm at step ST2, the procedure proceeds to step ST9. At step ST9, the set of die holders 53 and 54 in the first station S1 is returned to the initial position. That is, the set of die holders 53 and 54 seen from the upper side is rotated 7 clockwise by a third rotation angle θ₃ (θ₃=Nm×θ₁). Therefore, as shown in FIG. 18, the total rotation angle of holders in the first station S1 is reset at zero.

Then, when the press blanking cycle at steps ST3 to ST8 has been repeatedly performed to pile, on the cylinder 71, the core piece 20 partially shaped in the first station S1 just before the returning of the set of die holders 53 and 54 to the initial position, one laminated stator core 11 composed of Nm core pieces 20 piled up in layers is formed on the cylinder 71. At step ST10, the cylinder 71 is dropped down to place the laminated stator core 11 in the space 52b, and the member 73 discharges the laminated stator core 11 from the apparatus M1. Then, at step ST11, the cylinder 71 is lifted up to be returned to the initial position. Therefore, one core manufacturing cycle for manufacturing one core piece 20 is completed. Then, the procedure returns to step ST1. This procedure is continued until the electric power supplied to the apparatus M1 is stopped.

The press blanking operation performed in each station is described in detail.

As shown in FIG. 11 and FIG. 12, in the first station S1, the apparatus M1 punches holes in the plate 10 every press blanking operation by using a combination of die 63 and punch 64. The set of die holders 53 and 54 holding the die 63 and the punch 64 is rotated by a small angle each time the plate 10 is blanked out (see FIG. 15). Therefore, the apparatus M1 forms the surfaces 23 and surfaces 25a (see FIG. 16) of one core piece 20 at changeable positions of the core piece 20 every press blanking operation. Each surface 25a corresponds to a part of one surface 25 adjacent to one surface 23 in each core piece 20. Positions of the surfaces 23 in each core piece 20 are differentiated from those in the other core pieces 20 so as to change the width W of the teeth portions 26 every press blanking operation. This press blanking operation in the first station S1 corresponds to a movable station press blanking operation.

As shown in FIG. 11 and FIG. 13, in the second station S2, the apparatus M1 punches holes in the plate 10 by using the combination of die 66 and punch 65 to form the surfaces 24 and surfaces 25b (see FIG. 16) of each core piece 20 at fixed positions of the core piece 20. The surfaces 25b correspond to the other parts of the surfaces 25 adjacent to the surfaces 24 of the core piece 20. This press blanking operation in the second station S2 corresponds to a fixed station press blanking operation.

In the third station S3, the apparatus M1 punches holes in the plate 10 by using a combination of die 67 and punch paired with the die 67 to form the surfaces 21 of each core piece 20 at fixed positions of the core piece 20.

Further, in a binding hole forming station (not shown) subsequent to the third station S3, the apparatus M1 forms the holes 14 of the core piece 16 in the plate 10, in the same manner as in the prior art. In a binding projection forming station (not shown) subsequent to the binding hole forming station, the apparatus M1 forms the projections 15 of one core piece 17 or 18 in the plate 10 every press blanking operation, in the same manner as in the prior art.

In the fourth station S4 subsequent to the binding projection forming station, the apparatus M1 punches a hole in the plate 10 every press blanking operation by using a combination of die 69 and punch 70 to form the surface 22 of each core piece 20. Therefore, one core piece 20 is produced every press blanking operation and is dropped onto the cylinder 71.

The apparatus M1 rotates the cylinder 71 by a small angle each time one core piece 20 is dropped onto the cylinder 71 such that two side walls 13b of each tooth 13 are formed to be inclined opposite to each other toward the circumferential direction substantially at the same angle. Therefore, a plurality of core pieces 20 are piled up on the cylinder 71. When the number of core pieces 20 piled up reaches a predetermined number, the cylinder 71 is lowered to place the stator core 11 in the space 52b, and the member 73 pushes the stator core 11 out of the apparatus M1.

Here, in the forming stations, the holes 14 and projections 15 are positioned such that, when an upper-layer core piece 20 is dropped onto a lower-layer core piece 20, the projections 15 of the upper-layer core piece 20 are automatically inserted into the hollows of the projections 15 of the lower-layer core piece 20 or the holes 14 of the lower-layer core piece 16. Therefore, the core pieces 20 in the core 11 are automatically bound to one another when the core pieces 20 are piled up on the cylinder 71.

To position the holes 14 and projections 15 such that the core pieces 20 are bound to one another, the apparatus M1 may form the holes 14 and projections 15 while rotating each of the forming stations in the horizontal plane every formation of the holes 14 or projections 15 of one core piece 20. For example, each of the forming stations is rotated in the direction opposite to that of the rotation of the cylinder 71 at the same angle as in the rotation of the cylinder 71. In this case, as shown in FIG. 9, positions of the holes 14 or projections 15 in each core piece 20 are differentiated from those in the other core pieces 20. Therefore, although the cylinder 71 is rotated every formation of the core piece 20, the holes 14 and projections 15 of the laminated stator core 11 can be aligned along the axial direction. Alternatively, the apparatus M1 may form each of the holes 14 and projections 15 in an arc shape extending along the circumferential direction at a fixed position of the core piece 20 while fixing each of the forming stations in the horizontal plane. Therefore, although positions of the holes 14 or projections 15 in each core piece 20 are differentiated from those in the other core pieces 20 on the cylinder 71, the shape of each hole 14 or projection 15 lengthened along the circumferential direction compensates for positional differences along the axial direction among the holes 14 and projections 15 of the core pieces 20.

As described above, in the first embodiment, the apparatus M1 is partitioned into the press stations S1 to S4 aligned at equal intervals on a feeding path of the steel plate 10 and has a punch and a die paired with each other in each press station. The apparatus M1 blanks out a portion of the plate 10 every press blanking cycle in each station by using the punches and dies, while feeding the plate 10 by the interval between stations each time the plate 10 is blanked out, to produce one core piece 20 in the station S4. In other words, the apparatus M1 punches a hole in the plate 10 to form a part of the core piece 20 in each station every press blanking cycle and produces the core piece 20 having the holes every press blanking cycle. Then, the apparatus M1 piles up a predetermined number of core pieces 20 produced in a period of time corresponding to a predetermined number of cycles to manufacture one laminated stator core 11 and discharges the laminated stator core 11 out of the apparatus M1.

In this production of the core piece 20, the apparatus M1 changes the position of a hole formed in the first station S1 to differentiate the position of the hole in each core Piece 20 from those in the other core pieces 20, while fixing positions of holes formed in the other stations S2 to S4. More specifically, the apparatus M1 blanks out the plate 10 twice in the first and second stations S1 and S2 to set a changeable width W of the magnetic pole portion 27 in each core piece 20.

Accordingly, the width W of the portion 27 can be arbitrarily set for each of the core pieces 20 composing the laminated stator core 11, so that various types of laminated stator cores having different shapes can be efficiently manufactured at low cost in a small-sized manufacturing apparatus. That is, when the laminated stator core 11 is used for a motor, torque ripple and cogging torque caused in the motor can be reduced efficiently at low cost.

Further, when each core piece 20 is piled on another core piece 20 in the fourth station S4, a rotation mechanism composed of the cylinder 71 and the driving member 72 rotates the core piece 20 by a predetermined rotation angle along the circumferential direction of the core piece 20. Therefore, each of the core pieces 20 having different shapes can be placed at a predetermined lamination position in the laminated stator core 11 so as to form a predetermined layer in the core 11. Accordingly, the degree of freedom in shape of the core 11 can be improved, and various types of laminated stator cores having different shapes can be efficiently manufactured. Particularly, a motor can have an optimum laminated stator core for reduction of torque ripple and cogging torque caused in the motor.

Moreover, the guide posts 55 keep the relative position of the holder 54 to the holder 53 in the horizontal plane. Therefore, even when the die 63 and the punch 64 held on the holders 53 and 54 are rotated in the horizontal plane, relative positions of the die 63 and the punch 64 to each other in the horizontal plane are fixed. Accordingly, the surfaces 23 and parts of the surfaces 25 of each core piece 20 can be formed in the plate 10 with high precision, regardless of the rotation of the set of die 63 and punch 64.

Furthermore, when the apparatus M1 blanks out the plate 10 in the first station S1, a station rotating mechanism of the station S1 rotates the set of die 63 and punch 64 by a predetermined rotation angle every press blanking operation. The rotating mechanism has the gears 59, 60 and 62 to transmit a rotational force generated in the motor 61 to the base 56 through the gears. Therefore, the rotating mechanism with the gears can be manufactured in a simple structure. Accordingly, because of a simple structure in the rotating mechanism, the rotating mechanism can rotationally move the first station S1 at high speed so as to produce core pieces 20 having different shapes with high precision.

In this embodiment, the set of die holders 53 and 54 in the first station S1 is rotated every press blanking cycle to differentiate positions of the surfaces 23 in each core piece 20 from those in the other core pieces 20. However, the set of die holders 53 and 54 may be rotated only when the surfaces 23 and parts of the surfaces 25 of a particular core piece 20 among the core pieces 20 are formed, while the positions of the surfaces 23 in the other core pieces 20 are fixed. Further, the set of die holders 53 and 54 may be rotated every position differentiating cycle longer than the press blanking cycle.

Further, after the surfaces 23 of each core piece 20 are formed in changeable positions of the core piece 20 in the first station S1, the surfaces 24 of the core piece 20 are formed in fixed positions of the core piece 20 in the second station S2. However, the surfaces 23 of each core piece 20 may be formed in changeable positions of the core piece 20 after the surfaces 24 of the core piece 20 are formed in fixed positions of the core piece 20.

Moreover, the holes 14 or projections 15 are formed in each core piece 20 to automatically bind the core pieces 20 to one another. However, no holes or projections may be formed in the core pieces 20. In this case, after the core pieces 20 not bound to one another is pushed out of the apparatus M1, the core pieces 20 may be bound to each other by means of a binding member to form one laminated stator core 11.

### Embodiment 2

In the first embodiment, the first station S1 acts as a movable station, and second station S2 acts as a fixed station so as to fix positions of the die 65 and punch 66 in the horizontal plane. However, in addition to the first station S1, the second station may act as a movable station.

FIG. 19 is a plan view of the lower die 2 according to the second embodiment of the present invention.

An apparatus M2 for manufacturing one laminated stator core 11 according to the second embodiment differs from the apparatus M1 in that the apparatus M2 has a second station S2A acting as a movable station. As shown in FIG. 19, the second station S2A of the apparatus M2 has a die holder 68 holding a die 65A and a punch holder (not shown) holding a punch paired with the die 65A, and a combination of the holders is disposed so as to be rotatable in the horizontal plane independently from the frames 51 and 52. The rotation mechanism of the second station S2A is the same as that of the first station S1 shown in FIG. 12, so that a more detailed explanation of the rotation mechanism is omitted. Further, a laminated stator core manufactured in the apparatus M2 is the same as the stator core 11 (see FIG. 8) manufactured in the apparatus M1 shown in FIG. 7, so that detailed explanation and diagrams of the stator core are omitted.

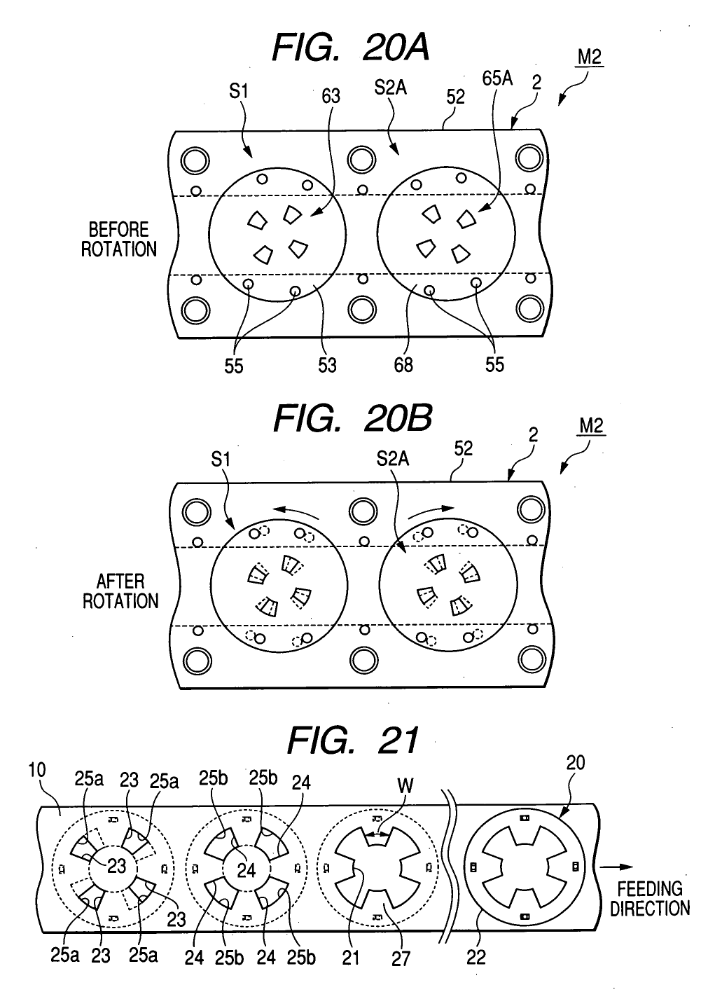

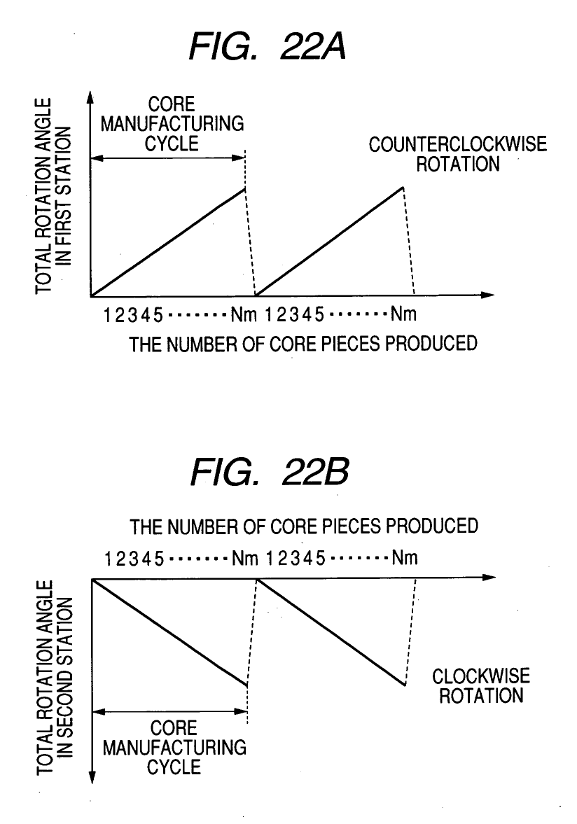

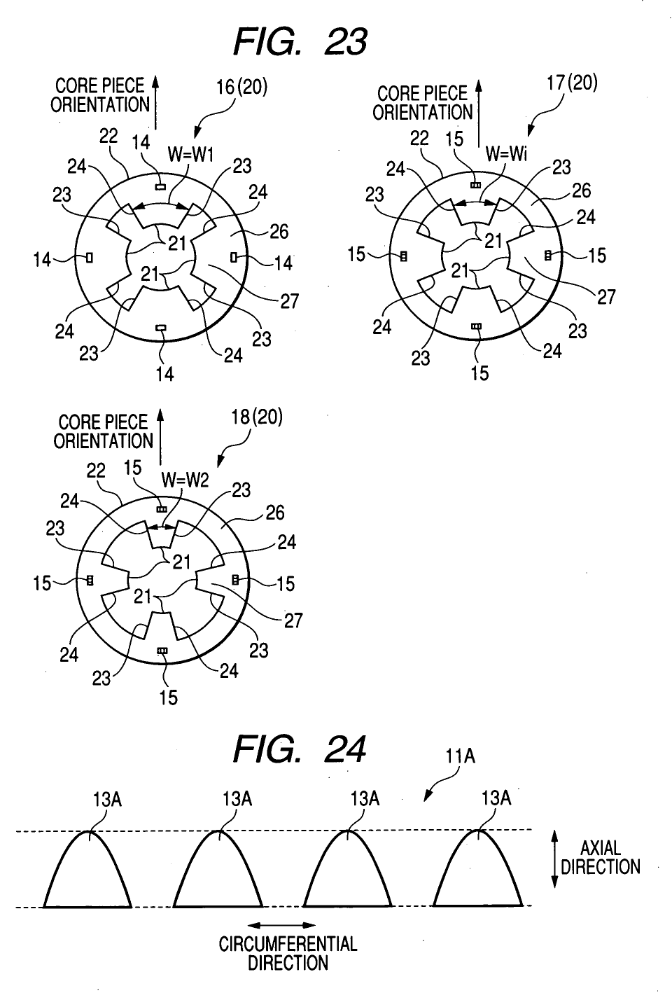

Operation of the apparatus M2 is described with reference to FIG. 19 to FIG. 23. FIG. 20A is a plan view of die holders of the first and second stations before a rotation of each die holder for the surface formation of one core piece 20, while FIG. 20B is a plan view of the die holders of the first and second stations after a rotation of each die holder for the surface formation of one core piece 20. FIG. 21 is a plan view of the plate 10 blanked out to form a part of one core piece 20 in each of the stations S1 to S4. In FIG. 21, a solid line indicates a cutting line of the plate 10 actually cut, and a dotted line indicates a cutting line of the plate 10 planned to be cut. FIG. 22 shows the relationship between the number of produced core pieces 20 and the total rotation angle of holders in each of the first and second stations S1 and S2A. FIG. 23 is a plan view of three representative types of core pieces finally produced in the fourth station S4 of the apparatus M2.

As shown in FIG. 21, in the first station S1, the apparatus M2 blanks out a portion of the plate 10 every press blanking operation by using the set of die 63 and punch 64. Further, as shown in FIG. 20A and FIG. 20B, the apparatus M2 rotates counterclockwise the set of holders 53 and 54 seen from the upper side by a rotation angle θ₄ (e.g., θ₄=0.5×θ₁) every press blanking operation while keeping the relative position of the die 63 to the punch 64 in the horizontal plane. Therefore, the set of die 63 and punch 64 is rotated by the angle θ₄ every press blanking operation, and the apparatus M2 forms the surfaces 23 and the surfaces 25a (i.e., parts of the surfaces 25 adjacent to the surfaces 23) of the magnetic pole portions 27 of each core piece 20 at changeable positions of the core piece 20.

As shown in the upper half of FIG. 22, the set of die 63 and punch 64 in the first station S1 is rotated counterclockwise every press blanking cycle until the number Nc of core pieces 20 produced in the apparatus M2 reaches the maximum core piece number Nm.

As shown in FIG. 21, in the second station S2A, the apparatus M2 blanks out a portion of the plate 10 every press blanking operation by using the die 65A and a punch paired with the die 65A. Further, as shown in FIG. 20A and FIG. 20B, when the set of die 65A and punch paired with the die 65A is seen from the upper side, the apparatus M2 rotates clockwise the set of die 65A and punch by the rotation angle θ every press blanking operation. Therefore, the apparatus M2 forms the surfaces 24 and surfaces 25b (i.e., remaining parts of the surfaces 25 adjacent to the surfaces 24) of the magnetic pole portions 27 of each core piece 20 at changeable positions of the core piece 20.

In the operation of the stations S1 and S2A, the set of die 65A and punch paired with the die 65A is rotated in the horizontal plane in a rotational direction opposite to that in the rotation of the set of die 63 and punch 64. Therefore, a distance between the surfaces 23 and 24 facing each other across a hole is enlarged every press blanking operation. In other words, the width W of each magnetic pole portion 27 is narrowed every press blanking operation.

As shown in the lower half of FIG. 22, the set of die 65A and punch paired with the die 65A in the second station S2A is rotated clockwise every press blanking cycle until the number Nc of core pieces 20 produced in the apparatus M2 reaches the maximum core piece number Nm.

In the third station S3, in the same manner as in the first embodiment, the apparatus M2 blanks out a portion of the plate 10 every press blanking operation by using the set of die 67 (see FIG. 11) and punch paired with the die 67 to form the surface 21 of one core piece 20.

Further, in a binding hole forming station (not shown) subsequent to the third station S3, the apparatus M2 forms the holes 14 of the core piece 16 in the plate 10. In a binding projection forming station (not shown) subsequent to the binding hole forming station, the apparatus M2 forms the projections 15 of one core piece 17 or 18 in the plate 10 every press blanking operation.

In the fourth station S4 subsequent to the binding projection forming station, in the same manner as in the first embodiment, the apparatus M2 punches a hole in the plate 10 every press blanking operation by using a combination of die 69 and punch 70 to form the surface 22 of each core piece 20. Therefore, one core piece 20 is produced every press blanking operation and is dropped onto the cylinder 71.

The apparatus M2 repeatedly performs the operation, and a plurality of core pieces 20 are piled up on the cylinder 71. In this case, because of the rotation angle in the second station S2A equal to the rotation angle in the first station S1, as shown in FIG. 23, in each core piece 20 just produced in the fourth station S4, the core piece orientation from the center of the core piece 20 to the center of one tooth portion 27 of the core piece 20 is the same as those in the other core pieces 20. Therefore, rotation of the cylinder 71 in the horizontal plane is not required to align the projections 14 and holes 15 of the core pieces 20 in the axial direction.

When the number Nc of core pieces 20 piled up on the cylinder 71 reaches a predetermined number Nm required to manufacture one laminated stator core 11, the member 73 discharges the core pieces 20 bound to one another as one laminated stator core 11 out of the apparatus M2.

Further, as shown in FIG. 22A and FIG. 22B, when the number Nc reaches the number Nm, the set of holders 53 and 54 is rotated clockwise to return the set of die 63 and punch 64 to the initial position, and the set of die 65A and punch paired with the die 65A is rotated counterclockwise to return the set of die 65A and punch paired with the die 65A to an initial position. That is, the total rotation angle of holders in each of the first and second stations S1 and S2A is reset at zero.

As described above, in the second embodiment, in addition to the first station S1 rotated every press blanking operation, the apparatus M2 has the second station S2A rotated every press blanking operation to shift the position of each surface 24 in the core piece 20 along the circumferential direction from that in another core piece 20 produced just before the production of the core piece 20.

That is, in the first station S1, the apparatus M2 blanks out a portion of the plate 10 every press blanking cycle to form the surface 23 of each magnetic pole portion 27 of one core piece 20 at a changeable position of the core piece 20 every press blanking cycle. In the second station S2A, the apparatus M2 blanks out another portion of the plate 10 every press blanking cycle to form the surface 24 of each magnetic pole portion 27 of one core piece 20 at a changeable position of the core piece 20 every press blanking cycle.

Therefore, because each magnetic pole portion 27 is shaped in two stations, shapes of the core pieces 20 can be arbitrarily changed based on the lamination position of each core piece 20 in the laminated stator core 11. Accordingly, a plurality of laminated stator cores 11 having different shapes can be efficiently manufactured at low cost.

These embodiments should not be construed as limiting the present invention to structures of those embodiments, and the structure of this invention may be combined with that based on the prior art.

### Modification 1

In the embodiments above described, as shown in FIG. 8 and FIG. 10, each tooth 13 is substantially formed in a frustum of pyramid so as to have the inner circumferential wall 13a shaped in a trapezoid and two sidewalls 13b. However, an inner circumferential wall of each tooth 13 can be formed in an arbitrary shape. For example, an inner circumferential wall of each tooth 13 may be shaped by a sine wave line so as to have two side walls each of which is curved in a sine wave.

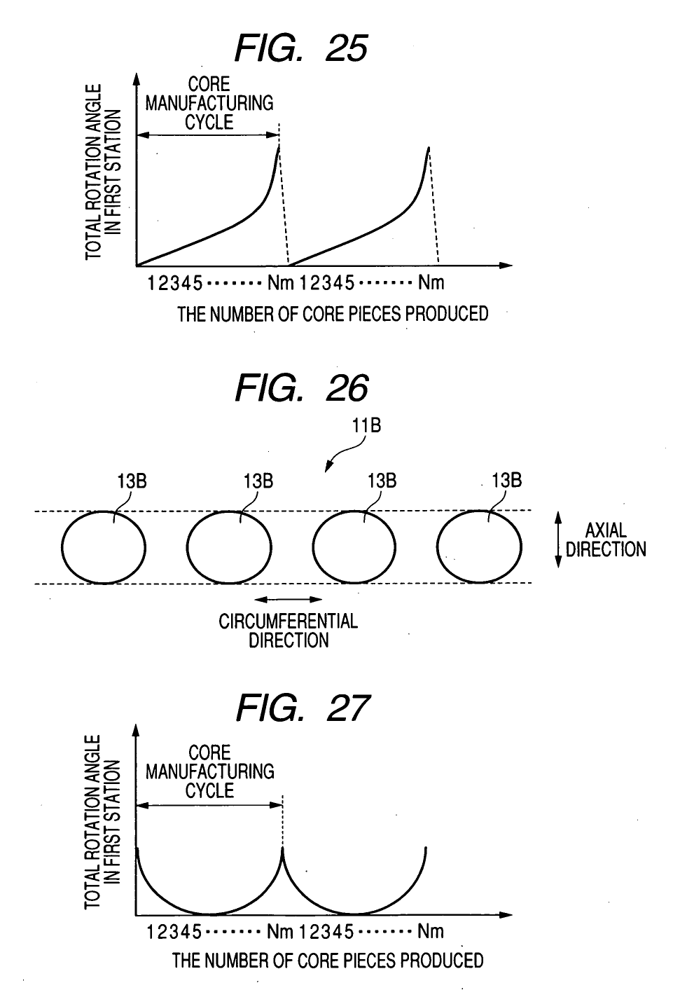

FIG. 24 is a view of inner circumferential walls spread out along the circumferential direction in a laminated stator core manufactured according to a first modification based on the first embodiment, and FIG. 25 shows the relationship between the number of produced core pieces and the total rotation angle of holders in the first station S1 according to the first modification.

As shown in FIG. 24, a laminated stator core 11A manufactured in the apparatus M1 according to the first modification has four magnetic pole teeth 13A, and each magnetic pole tooth 13A is formed to have an inner circumferential wall shaped like a sine wave line. In other words, each magnetic pole tooth 13A is formed to have two side walls each of which is curved in a sine wave.

In a manufacturing method according to the first modification, the apparatus M1 rotates counterclockwise a combination of holders 53 and 54 in the first station S1 by a changeable rotation angle every press blanking operation in the horizontal plane such that the total rotation angle of holders in the first station S1 satisfies the relationship shown in FIG. 25. That is, the rotation angle is gradually increased every press blanking operation when the number of produced core pieces is small in one core manufacturing cycle, while the rotation angle is rapidly increased every press blanking operation when the number of produced core pieces is large in one core manufacturing cycle. Further, the cylinder 71 is rotated counterclockwise by a half of the rotation angle each time one core piece is produced. Therefore, the laminated stator core 11A shown in FIG. 24 is manufactured in the apparatus M1.

Accordingly, the laminated stator core 11A having the teeth 13A shaped in a sine wave can be efficiently manufactured at low cost.

Further, because a winding wound on the core 11A is bent along walls curved in a sine wave, a magnetic flux changed to a sine wave shape is induced in a motor using the core 11A. Accordingly, torque ripple and cogging torque caused in the motor can be reduced.

This modification can be also applied for the second embodiment.

### Modification 2

Each tooth in a laminated stator core may be formed in a columnar shape so as to have an inner circumferential wall formed in an elliptical shape or in a circular shape. FIG. 26 is a view of inner circumferential walls spread out along the circumferential direction in a laminated stator core manufactured according to a second modification based on the first embodiment, and FIG. 27 shows the relationship between the number of produced core pieces and the total rotation angle of holders in the first station S1 according to the second modification.

As shown in FIG. 26, a laminated stator core 11B is manufactured in the apparatus M1 according to the second modification to have four magnetic poles teeth 13B. Each tooth 13B is formed in a columnar shape so as to have an inner circumferential wall formed in an elliptical shape.

In a manufacturing method according to the second modification, the apparatus M1 rotates a combination of holders 53 and 54 in the first station S1 by a changeable rotation angle every press blanking operation in the horizontal plane such that the total rotation angle of holders in the first station S1 satisfies the relationship shown in FIG. 27. More specifically, when the number of produced core pieces is smaller than a half of the number Nm in one core manufacturing cycle, the apparatus M1 clockwise rotates the combination of holders 53 and 54 while decreasing the rotation angle every press blanking operation and finally setting the rotation angle at zero. When the number of produced core pieces becomes larger than a half of the number Nm in one core manufacturing cycle, the apparatus M1 rotates counterclockwise the combination of holders 53 and 54 while increasing the rotation angle from the zero value every press blanking operation. Further, the cylinder 71 is rotated by a half of the rotation angle each time one core piece is produced. Therefore, the laminated stator core 11B shown in FIG. 26 is manufactured in the apparatus M1.

Accordingly, the laminated stator core 11B having the teeth 13B formed in an elliptical shape can be efficiently manufactured at low cost.

Further, because a winding wound around each magnetic pole tooth 13B of the core 11B is bent on each curved wall, the winding is smoothly deformed. Accordingly, damage caused to the winding during manufacture can be reduced.

This modification can be also applied for the second embodiment.

### Modification 3

A method and an apparatus for manufacturing a laminated stator core used for a four-pole type four-phase AC (alternating current) motor are described according to a third modification based on the second embodiment.

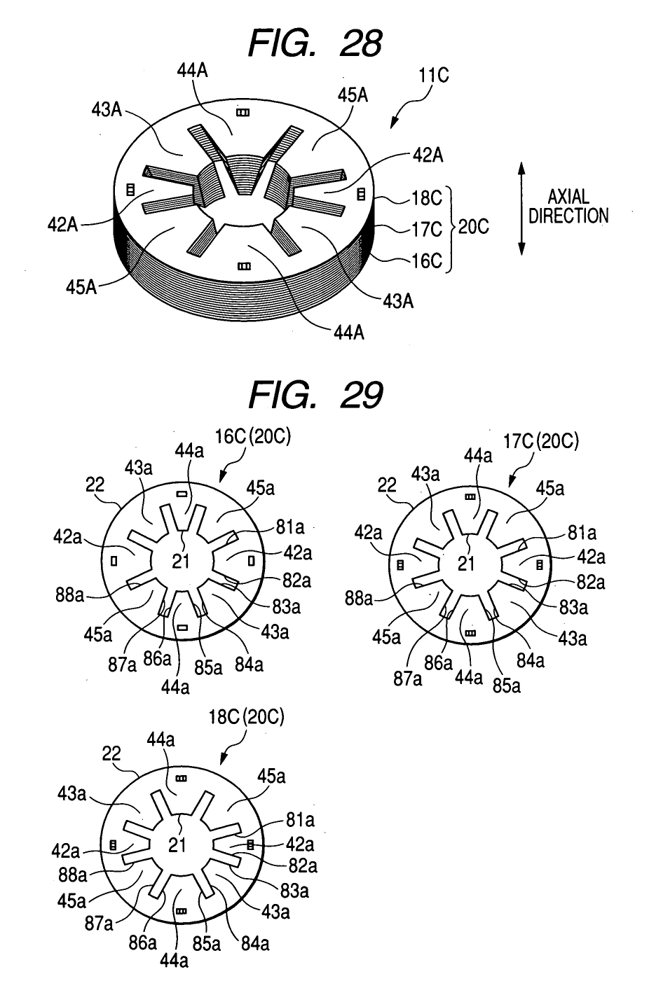

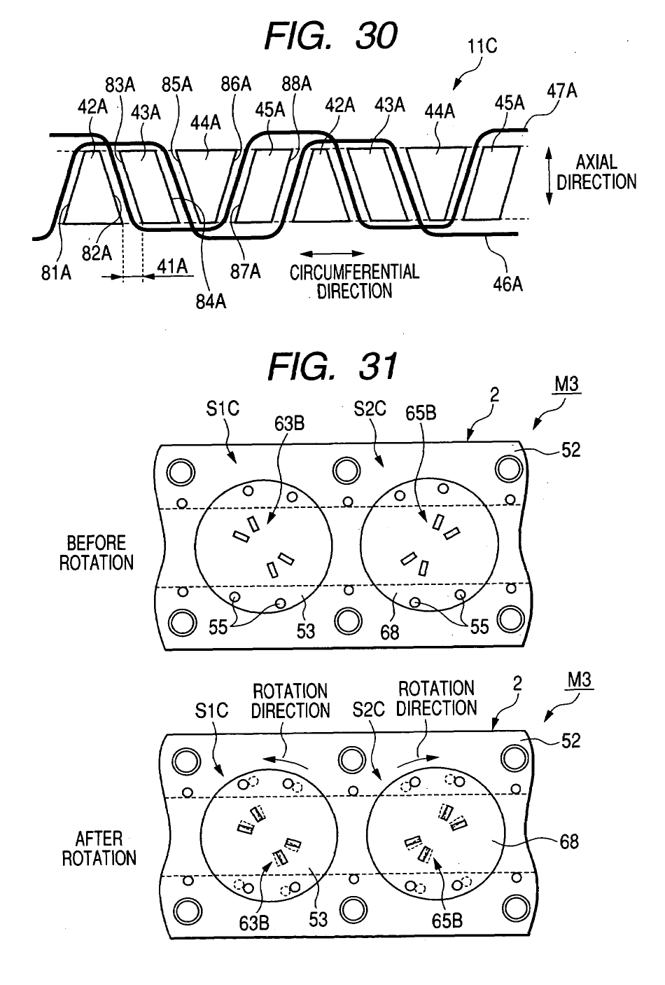

FIG. 28 is a perspective side view of a laminated stator core 11C, and FIG. 29 is a plan view of three representative types of core pieces. FIG. 30 is a view of inner circumferential walls of respective magnetic pole teeth spread out along the circumferential direction in the stator core. A laminated stator core 11C shown in FIG. 28 is used for a four-pole type four-phase AC motor. In FIG. 30, a winding 46A formed in a loop shape and a winding 47A formed in a loop shape are wound on magnetic pole teeth of the core 11C to obtain a stator.

As shown in FIG. 28, the core 11C is obtained by piling up a predetermined number of core pieces 20C (see FIG. 29) along an axial direction of the core 11C. The core 11C differs from the core 11 shown in FIG. 8 in that the core 11C has two groups of magnetic pole teeth. Each group has four magnetic pole teeth 42A, 43A, 44A and 45A disposed in that order along a circumferential direction (i.e., rotational direction) of the core 11C.

As shown in FIG. 30, the teeth 42A and 44A are substantially formed in the same shape such that the shapes of the teeth 42A and 44A are inverted to each other with respect to the axial direction of the core 11C. Each of the teeth 42A and 44A is substantially formed in a frustum of pyramid so as to have an inner circumferential wall, formed in a trapezoidal shape, and two side walls each of which is formed in a rectangular shape. The teeth 43A and 45A are substantially formed in the same shape such that the shapes of the teeth 43A and 45A are inverted to each other with respect to the axial direction. Each of the teeth 43A and 45A is substantially formed in a parallelepiped so as to have an inner circumferential wall formed in a parallelogram and two side walls each of which is formed in a rectangular shape.

Each tooth 42A has a right side wall 81A and a left side wall 82A. Each tooth 43A has both a right side wall 83A facing the wall 82A and a left side wall 84A. Each tooth 44A has both a right side wall 85A facing the wall 84A and a left side wall 86A. Each tooth 45A has both a right side wall 87A facing the wall 86A and a left side wall 88A facing the wall 81A. Each of the walls 81A to 88A has a curved surface. The distance 41A between two adjacent teeth in each pair is set to be substantially constant along the axial direction. The distance 41A in each pair of teeth is substantially equal to that in the other pairs.

As shown in FIG. 29, the core pieces 20C are represented by a type of core piece 16C forming the lowermost layer of the core 11C, a type of core piece 17C forming each of middle layers, and a type of core piece 18C forming the uppermost layer. Each core piece 20C differs from the core piece 20 shown in FIG. 9 in that the core piece 20C has two groups of magnetic pole tooth portions. Each group has four magnetic pole tooth portions 42a, 43a, 44a and 45a disposed in that order along the circumferential direction of the core piece 20C. A lamination of portions 42a forms one magnetic pole tooth 42A of the core 11C, a lamination of portions 43a forms one magnetic pole tooth 43A of the core 11C, a lamination of portions 44a forms one magnetic pole tooth 44A of the core 11C, and a lamination of portions 45a forms one magnetic pole tooth 45A of the core 11C. Each tooth portion 42a has an inner circumferential surface 21, a right side surface 81a and a left side surface 82a. Each tooth portion 43a has an inner circumferential surface 21, a right side surface 83a and a left side surface 84a. Each tooth portion 44a has an inner circumferential surface 21, a right side surface 85a and a left side surface 86a. Each tooth portion 45a has an inner circumferential surface 21, a right side surface 87a and a left side surface 88a. Each core piece 20C has an outer circumferential surface 22 and other inner circumferential surfaces.

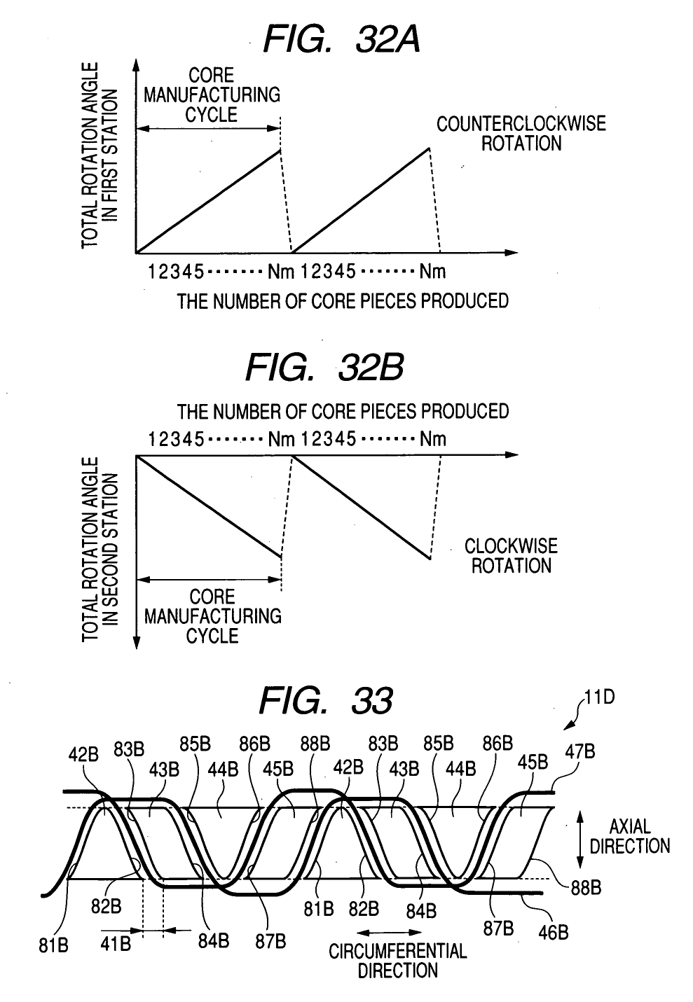

A method and an apparatus for manufacturing one laminated stator core 11C having the magnetic pole teeth 42A, 43A, 44A and 45A are described. FIG. 31 is a plan view of both a set of die holders not yet rotated and a set of the die holders rotated in an apparatus M3 according to the third modification based on the second embodiment. FIG. 32A shows the relationship between the number of produced core pieces and the total rotation angle of holders in the first station, while FIG. 32B shows the relationship between the number of produced core pieces and the total rotation angle of holders in the second station. The core pieces 20C shown in FIG. 29 are produced in an apparatus M3 partially shown in FIG. 31, and the laminated stator core 11C shown in FIG. 28 is manufactured in the apparatus M3.

As shown in FIG. 31, the apparatus M3 has a first station SiC and a second station S2C, in addition to the stations S3 and S4 (not shown). Each of the stations SiC and S2C is rotationally movable in the same manner as those in the second embodiment. The apparatus M3 has the die holders 53 and 68 and punch holders (not shown) in the stations S1C and S2C, and a combination of die holder and punch holder in each station is rotated independently from the frames 51 and 52 fixing the stations S3 and S4. The die holder 53 holds a die 63B in the first station SiC, and the die holder 68 holds a die 65B in the second station S2C. Each of the dies 63B and 65B has four rectangular holes disposed along a circumferential direction of a circle defined by the holes, so that four holes can be opened in the plate 10 every press blanking operation by using a set of die 63B or 65B and punch paired with the die in each of the stations S1C and S2C. A rotation mechanism in each of the stations S1C and S2C is the same as that of the first station S1 shown in FIG. 12, so that a more detailed explanation of the rotation mechanism is omitted.

As shown in FIG. 30, in each core piece 20C, the walls 82A and 83A facing each other and the walls 84A and 85A facing each other are inclined in a first circumferential direction with respect to the axial direction. Further, the walls 81A and 88A facing each other and the walls 86A and 87A facing each other are inclined in a second circumferential direction opposite to the first circumferential direction. Therefore, the walls 81A to 88A are classified into a first group of walls 82A, 83A, 84A and 85A and a second group of walls 81A, 86A, 87A and 88A. Further, the distance 41A in each pair of teeth is constant along the axial direction. Therefore, the surfaces 82a, 83a, 84a and 85a of one core piece 20C can be simultaneously formed in one station every press blanking operation so as to form the first group of walls 82A, 83A, 84A and 85A. Further, the surfaces 81a, 86a, 87a and 88a of one core piece 20C can be simultaneously formed in one station every press blanking operation so as to form the second group of walls 81A, 86A, 87A and 88A.

In a method for manufacturing the core 11C according to the third modification, the apparatus M3 forms the surfaces 82a, 83a, 84a and 85a of one core piece 20C in the first station SiC every press blanking cycle while rotating counterclockwise a combination of holders (i.e., the set of die 63B and punch paired with the die 63B) by a predetermined rotational angle every press blanking cycle so as to satisfy the relationship shown in FIG. 32A. Therefore, the first group of surfaces 82A, 83A, 84A and 85A in one laminated stator core 11C is formed in the first station S1C every core manufacturing cycle. Further, the apparatus M3 forms the surfaces 81a, 86a, 87a and 88a of one core piece 20C in the second station S2C every press blanking cycle while rotating clockwise a combination of holders (i.e., a set of die 65B and punch paired with the die 65B) by the predetermined rotational angle every press blanking cycle so as to satisfy the relationship shown in FIG. 32B. Therefore, the second group of walls 81A, 86A, 87A and 88A in one laminated stator core 11C is formed in the second station S2C every core manufacturing cycle.

In this manufacturing method, each of the teeth 42A and 44A is formed by two press blanking operations of the stations S1C and S2C. Then, the apparatus M3 forms the surfaces 21 of one core piece 20C in the third station every press blanking cycle and forms the surface 22 of one core piece 20C in the fourth station every press blanking cycle. Therefore, one laminated stator core 11C can be manufactured every core manufacturing cycle.

Accordingly, the laminated stator core 11C with the teeth 42A and 44A having inner circumferential walls formed in a trapezoidal shape and the teeth 43A and 45A having inner circumferential walls shaped in a parallelogram can be efficiently manufactured at low cost.

Further, because of the trapezoidal teeth and parallelogram-shaped teeth, torque ripple and cogging torque caused in a motor with the core 11C can be reduced, in the same manner as in a motor using a stator core with skew.

Moreover, because each of the windings 46A and 47A can be wound on each tooth of the core 11C along a direction inclined with respect to the axial direction, the length of each winding can be shortened, copper loss in the windings can be reduced, and a motor with the core 11C can be operated with high efficiency.

### Modification 4

Each of the magnetic pole teeth 42A to 45A in the core 11C according to the third modification may be deformed so as to have an inner circumferential wall, shaped in sine wave line(s), and side walls each of which is curved in a sine wave.

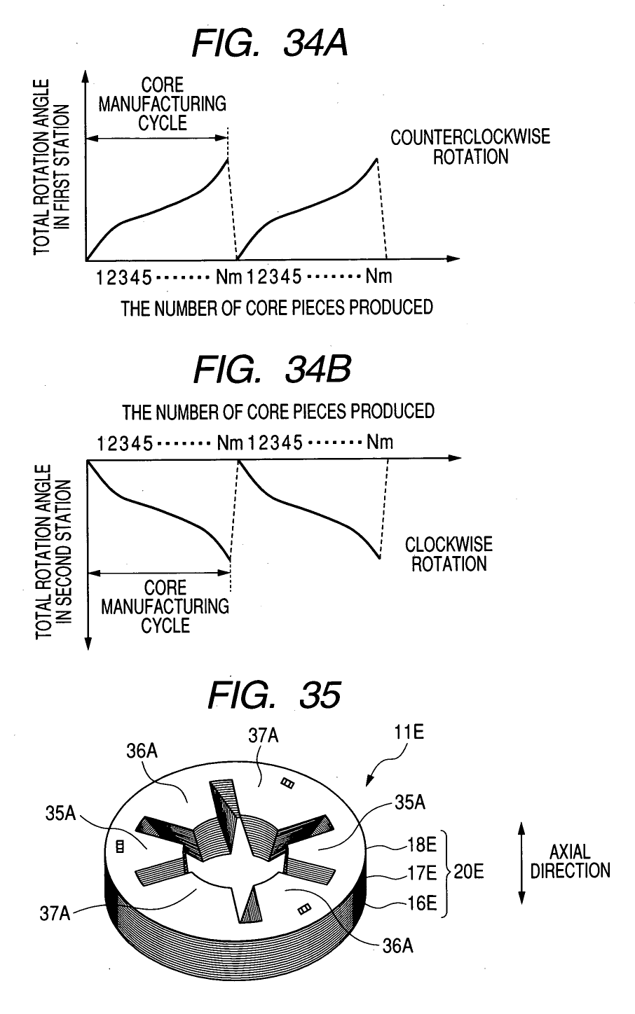

FIG. 33 is a view of inner circumferential walls of magnetic pole teeth spread out along the circumferential direction in a laminated stator core manufactured according to a fourth modification based on the second embodiment. FIG. 34A shows the relationship between the number of produced core pieces and the total rotation angle of holders in the first station S1C according to the fourth modification, while FIG. 34B shows the relationship between the number of produced core pieces and the total rotation angle of holders in the second station S2C according to the fourth modification. In FIG. 33, a winding 46B formed in a loop shape and a winding 47B formed in a loop shape are wound on magnetic pole teeth of a laminated stator core 11D to obtain a stator used for a four-pole type four-phase AC motor.

As shown in FIG. 33, a laminated stator core 11D manufactured according to the fourth modification differs from the core 11C shown in FIG. 30 in that each side wall of magnetic pole teeth of the core 11D is curved in a sine wave.

More specifically, the core 11D has two magnetic pole teeth 42B, two magnetic pole teeth 43B, two magnetic pole teeth 44B and two magnetic pole teeth 45B. Each tooth 42B has a right side wall 81B and a left side wall 82B. Each tooth 43B has both a right side wall 83B facing the wall 82B and a left side wall 84B. Each tooth 44B has both a right side wall 85B facing the wall 84B and a left side wall 86B. Each tooth 45B has both a right side wall 87B facing the wall 86A and a left side wall 88B facing the wall 81B. Each of the walls 81B to 88B is curved in a sine wave.

The teeth 42B and 44B are substantially formed in the same shape such that the shapes of the teeth 42B and 44B are inverted to each other with respect to the axial direction. Each of the teeth 42B and 44B is formed almost in a frustum of pyramid so as to have an inner circumferential wall, formed almost in a trapezoid with edges shaped as a sine wave line, and two side walls each of which is formed in a rectangular shape overall and is curved in a sine wave along the edges. The teeth 43B and 45B are substantially formed in the same shape such that the shapes of the teeth 43B and 45B are inverted to each other with respect to the axial direction. Each of the teeth 43B and 45B is formed almost in a parallelepiped so as to have an inner circumferential wall, formed almost in a parallelogram shaped with two sine wave lines, and two side walls each of which is formed almost in a rectangular shape and is curved in a sine wave. A distance 41B between two adjacent teeth in each pair is set to be substantially constant along an axial direction of the core 11D. The distance 41B in each pair of teeth is substantially equal to that in the other pairs.

In a method for manufacturing the core 11D, the change in the rotation angle in each of the first and second stations S1C and S2C differs from that in the method according to the third modification. More specifically, as shown in FIG. 31, the apparatus M3 rotates counterclockwise a combination of holders (i.e., the set of die 63B and punch paired with the die 63B) by a predetermined rotational angle in the first station SiC every press blanking cycle such that the total rotation angle of holders satisfies the relationship shown in FIG. 34A. Further, the apparatus M3 rotates clockwise a combination of holders (i.e., the set of die 65B and punch paired with the die 65B) by the predetermined rotational angle in the second station S2C every press blanking cycle such that the total rotation angle of holders satisfies the relationship shown in FIG. 34B.

Accordingly, the laminated stator core 11D can be efficiently manufactured at low cost such that the teeth 42B and 44B of the core 11D have inner circumferential walls formed in a trapezoid and side walls curved in a sine wave, while the teeth 43B and 45B of the core 11D have inner circumferential walls formed in a parallelogram and side walls curved in a sine wave.

Further, because the windings are wound on walls curved in a sine wave, magnetic flux induced in a motor using the core 11D is changed in a sine wave shape. Accordingly, torque ripple and cogging torque caused in the motor can be reduced.

Moreover, because each of the windings 46B and 47B is wound on each tooth of the core 11D along a direction inclined with respect to the axial direction, the length of each winding is shortened. Accordingly, copper loss in the windings can be reduced.

Furthermore, because the windings are wound on walls curved in a sine wave, the windings can be smoothly curved. Accordingly, damage caused to the winding during manufacture can be reduced.

### Modification 5

A method and an apparatus for manufacturing a laminated stator core used for a four-pole type three-phase AC motor are described.

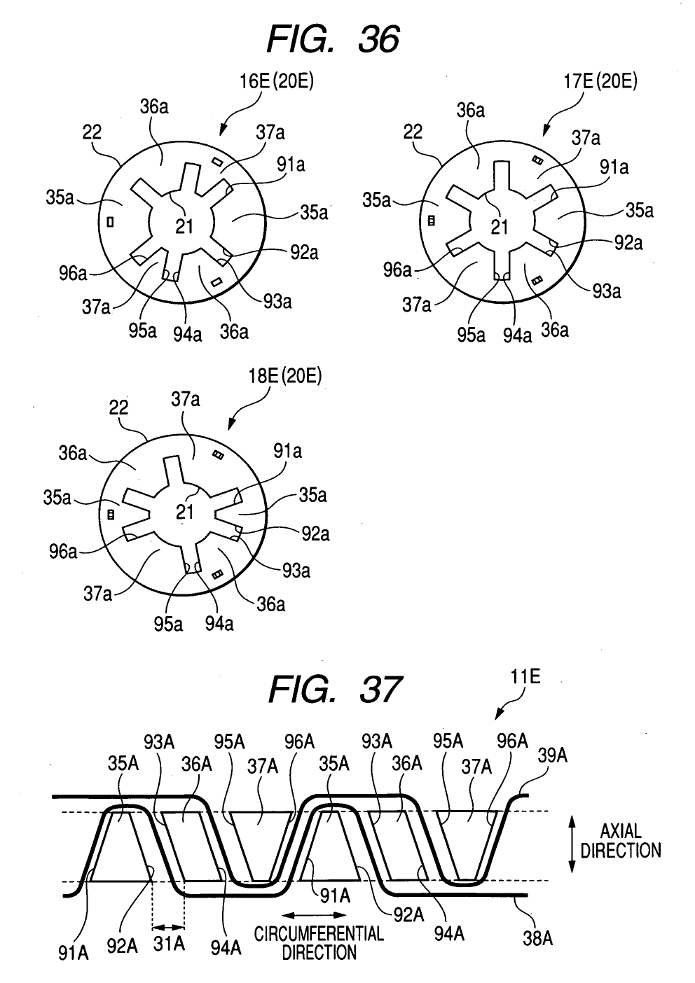

FIG. 35 is a perspective side view of a laminated stator core 11E manufactured according to the fifth modification based on the second embodiment, and FIG. 36 is a plan view of three representative types of core pieces in the core 11E. FIG. 37 is a view of inner circumferential walls of respective magnetic pole teeth of the core 11E spread out along the circumferential direction. In FIG. 37, a winding 38A formed in a loop shape and a winding 39A formed in a loop shape are wound on magnetic pole teeth of the core 11E to form a stator used for a four-pole type three-phase AC motor.

As shown in FIG. 35, the core 11E is obtained by piling up a predetermined number of core pieces 20E (see FIG. 36) along an axial direction of the core 11E. The core 11E differs from the core 11 shown in FIG. 8 in that the core 11E has two groups of magnetic pole teeth. Each group has three magnetic pole teeth 35A, 36A and 37A disposed in that order along a circumferential direction (i.e., rotational direction) of the core 11E. The teeth 35A, 36A and 37A correspond to a U phase, a V phase and a W phase, respectively.

As shown in FIG. 37, the teeth 35A and 37A are substantially formed in the same shape such that the shapes of the teeth 35A and 37A are inverted to each other with respect to the axial direction. Each of the teeth 35A and 37A is substantially formed in a frustum of pyramid so as to have an inner circumferential wall, formed in a trapezoidal shape, and two side walls each of which is formed in a rectangular shape. Each tooth 36A is substantially formed in a parallelepiped so as to have an inner circumferential wall formed in a parallelogram and two side walls each of which is formed in a rectangular shape.

Each tooth 35A has a right side wall 91A and a left side wall 92A. Each tooth 36A has both a right side wall 93A facing the wall 92A and a left side wall 94A. Each tooth 37A has both a right side wall 95A facing the wall 94A and a left side wall 96A. Each of the walls 35A to 37A has a curved surface. The distance 31A between two adjacent teeth in each pair is set to be substantially constant along the axial direction. The distance 31A in each pair of teeth is substantially equal to that in the other pairs.

As shown in FIG. 36, the core pieces 20E are represented by a type of core piece 16E forming the lowermost layer of the core 11E, a type of core piece 17E forming each of middle layers, and a type of core piece 18E forming the uppermost layer. Each core piece 20E differs from the core piece 20 shown in FIG. 9 in that the core piece 20E has two groups of magnetic pole tooth portions. Each group has three magnetic pole tooth portions 35a, 36a and 37a disposed in that order along the circumferential direction of the core piece 20E. A lamination of portions 35a forms one magnetic pole tooth 35A of the core 11E, a lamination of portions 36a forms one magnetic pole tooth 36A of the core 11E, and a lamination of portions 37a forms one magnetic pole tooth 37A of the core 11E. Each tooth portion 35a has an inner circumferential surface 21, a right side surface 91a and a left side surface 92a. Each tooth portion 36a has an inner circumferential surface 21, a right side surface 93a and a left side surface 94a. Each tooth portion 37a has an inner circumferential surface 21, a right side surface 95a and a left side surface 96a. Each core piece 20E has an outer circumferential surface 22 and other inner circumferential surfaces.

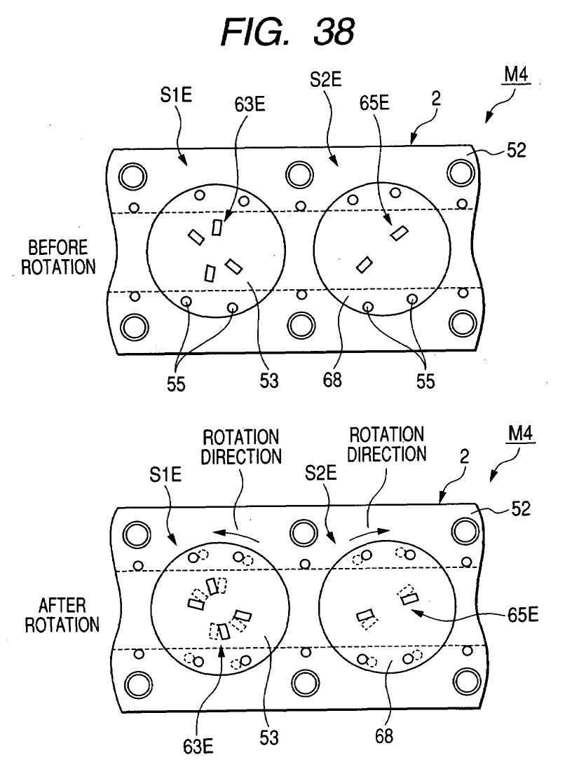

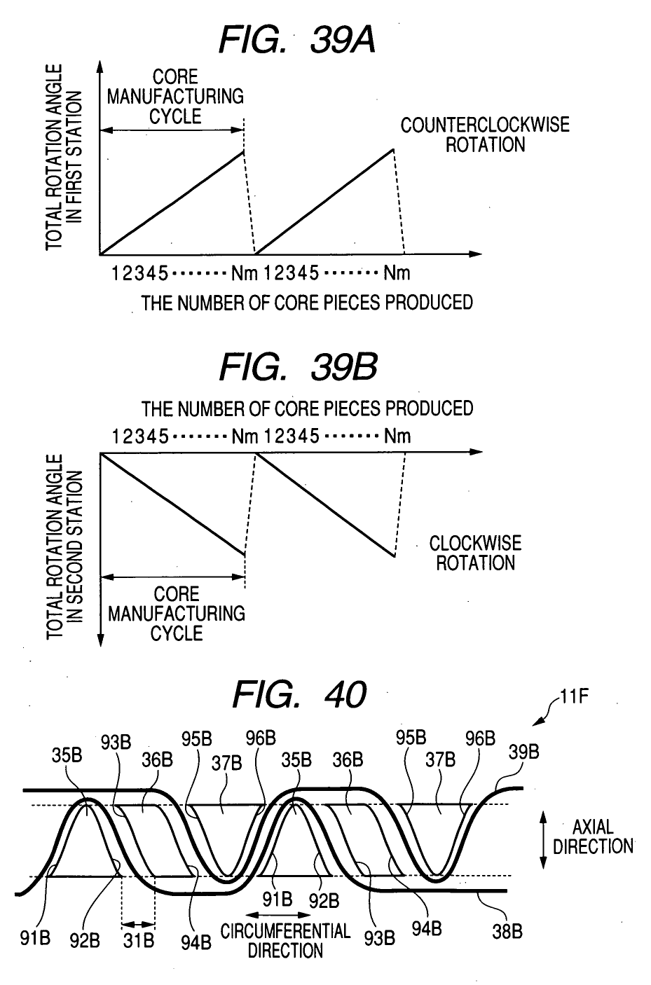

A method and an apparatus for manufacturing one laminated stator core 11E having the magnetic pole teeth 35A, 36A and 37A in an apparatus are described. FIG. 38 is a plan view of both a set of die holders not yet rotated and a set of die holders rotated in an apparatus M4 according to the fifth modification. FIG. 39A shows the relationship between the number of produced core pieces and the total rotation angle of holders in the first station, while FIG. 39B shows the relationship between the number of produced core pieces and the total rotation angle of holders in the second station. The core pieces 20E shown in FIG. 36 are produced in an apparatus M4 partially shown in FIG. 38, and the laminated stator core 11E shown in FIG. 35 is manufactured in the apparatus M4.

As shown in FIG. 38, the apparatus M4 has a first station S1E, a second station S2E and stations S3 and S4 (not shown). Each of the stations S1E and S2E is rotationally movable in the same manner as those in the third modification. The apparatus M4 has the die holders 53 and 68 and punch holders (not shown) in the stations S1E and S2E to be rotated in the horizontal plane independently from the frames 51 and 52 fixing the stations S3 and S4. The die holder 53 holds a die 63E in the first station S1E, and the die holder 68 holds a die 65E in the second station S2E. The die 63E has four rectangular holes disposed along a circumferential direction of a circle defined by the holes, so that four holes can be opened in the plate 10 every press blanking operation in each of the first station S1E. The die 65E has two rectangular holes disposed to be symmetric with respect to a center axis of the die 65E, so that two holes can be opened in the plate 10 every press blanking operation in each of the S2E. The rotation mechanism in each of the stations S1E and S2E is the same as that of the first station S1 shown in FIG. 12, so that a more detailed explanation of the rotation mechanism is omitted.

As shown in FIG. 30, in each core piece 20E, the walls 92A and 93A facing each other and the walls 94A and 95A facing each other are inclined in a first circumferential direction with respect to the axial direction. Further, the walls 91A and 96A facing each other are inclined in a second circumferential direction opposite to the first circumferential direction. Therefore, the walls 91A to 96A are classified into a first group of walls 92A, 93A, 94A and 95A and a second group of walls 91A and 96A. Further, the distance 31A in each pair of teeth is constant along the axial direction. Therefore, the surfaces 92a, 93a, 94a and 95a of one core piece 20E can be simultaneously formed in one station every press blanking operation so as to form the first group of walls 92A, 93A, 94A and 95A. Further, the surfaces 91a and 96a of one core piece 20E can be simultaneously formed in one station every press blanking operation so as to form the second group of walls 91A and 96A.

In a method for manufacturing the core 11E according to the fifth modification, the apparatus M4 forms the surfaces 92a, 93a, 94a and 95a of one core piece 20C in the first station S1E every press blanking cycle while rotating counterclockwise a combination of holders (i.e., the set of die 63E and punch paired with the die 63E) by a predetermined rotational angle every press blanking cycle so as to satisfy the relationship shown in FIG. 39A. Therefore, the first group of walls 92A, 93A, 94A and 95A in one laminated stator core 11E is formed in the first station S1E every core manufacturing cycle. Further, the apparatus M4 forms the surfaces 91a and 96a of one core piece 20C in the second station S2E every press blanking cycle while rotating clockwise a combination of holders (i.e., the set of die 65E and punch paired with the die 65E) by the predetermined rotational angle every press blanking cycle so as to satisfy the relationship shown in FIG. 39B. Therefore, the second group of walls 91A and 96A in one laminated stator core 11E is formed in the second station S2E every core manufacturing cycle.

In this manufacturing method, the apparatus M4 forms each of the teeth 35A and 37A by performing two press blanking operations in the stations S1E and S2E. Then, the apparatus M4 forms the surfaces 21 of one core piece 20E in the third station every press blanking cycle and forms the surface 22 of one core piece 20E in the fourth station every press blanking cycle. Therefore, one laminated stator core 11E can be manufactured every core manufacturing cycle.

The windings 38A and 39A are formed from the same conductive wire so as to have the same size and length. The windings 38A and 39A are wound so as to pass through respective paths which are inverted to each other with respect to the axial direction. A control for current passing through the windings 38A and 39A is described below. U-phase current, V-phase current and W-phase current will be indicated by Iu, Iv and Iw, respectively. A current control unit (not shown) controls power supplied such that a current Iu-Iv passes through the winding 38A, while a current Iv-Iw passes through the winding 39A. Therefore, a motor using a stator composed of the core 11E and the windings 38A and 39A can act as a three-phase AC motor.

Accordingly, the laminated stator core 11E with the teeth 35A and 37A having inner circumferential walls formed in a trapezoidal shape and the teeth 36A having inner circumferential walls shaped in a parallelogram can be efficiently manufactured at low cost.

Further, because of the trapezoidal teeth and parallelogram-shaped teeth, torque ripple and cogging torque caused in a motor with the core 11E can be reduced, in the same manner as in a motor using a stator core with skew.

Moreover, because each of the windings 38A and 39A can be wound on each tooth of the core 11E along a direction inclined with respect to the axial direction, the length of each winding can be shortened, copper loss in the windings can be reduced, and a motor with the core 11E can be operated with high efficiency.

### Modification 6

Each of the magnetic pole teeth 35A to 37A in the core 11E according to the fifth modification may be deformed to have side walls, each of which is curved in a sine wave, such that each tooth has an inner circumferential wall shaped in two sine wave lines.

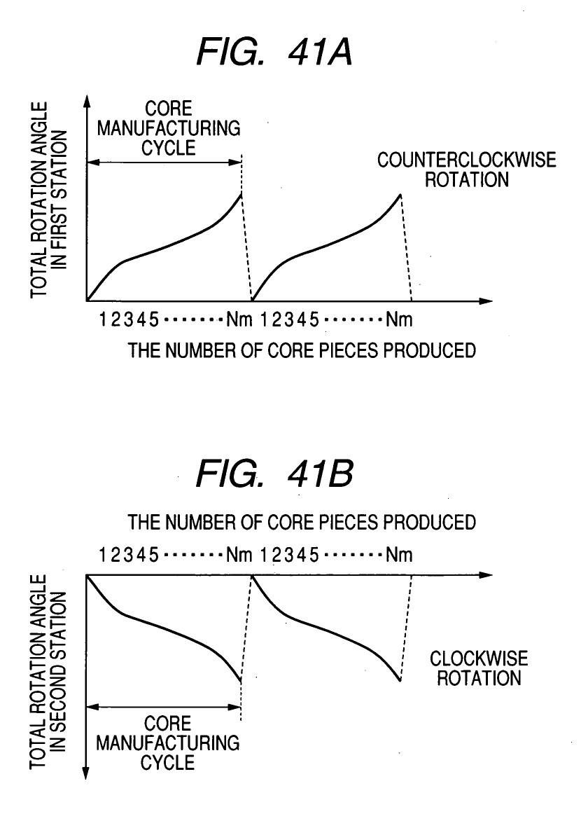

FIG. 40 is a view of inner circumferential walls of magnetic pole teeth spread out along the circumferential direction in a laminated stator core manufactured according to a sixth modification based on the second embodiment. FIG. 41A shows the relationship between the number of produced core pieces and the total rotation angle of holders in the first station S1E according to the sixth modification, while FIG. 41B shows the relationship between the number of produced core pieces and the total rotation angle of holders in the second station S2E according to the sixth modification. In FIG. 40, a winding 38B formed in a loop shape and a winding 39B formed in a loop shape are wound on magnetic pole teeth of a laminated stator core 11F to obtain a stator used for a four-pole type three-phase AC motor.

As shown in FIG. 40, a laminated stator core 11F differs from the core 11E shown in FIG. 37 in that each side wall of magnetic pole teeth of the core 11F is curved in a sine wave. More specifically, the core 11F has two group of teeth. Each group has three magnetic pole teeth 35B, 36B and 37B disposed in that order along a circumferential direction (i.e., rotational direction) of the core 11F. The teeth 35B, 36B and 37B correspond to a U phase, a V phase and a W phase, respectively.

The teeth 35B and 37B are substantially formed in the same shape such that the shapes of the teeth 35B and 37B are inverted to each other with respect to the axial direction. Each of the teeth 35B and 37B is formed almost in a frustum of pyramid so as to have an inner circumferential wall, formed almost in a trapezoid with edges shaped in a sine wave line, and two side walls each of which is formed in a rectangular shape and is curved in a sine wave. Each tooth 36B is formed almost in a parallelepiped so as to have an inner circumferential wall, formed almost in a parallelogram shaped in two sine wave lines, and two side walls each of which is formed almost in a rectangular shape and is curved in a sine wave.

Each tooth 35B has a right side wall 91B and a left side wall 92B. Each tooth 36B has both a right side wall 93B facing the wall 92B and a left side wall 94B. Each tooth 37B has both a right side wall 95B facing the wall 94B and a left side wall 96B. Each of the walls 35B to 37B is curved in a sine wave. A distance 31B between two adjacent teeth in each pair is set to be substantially constant along the axial direction. The distance 31B in each pair of teeth is substantially equal to that in the other pairs. The windings 38B and 39B are formed from the same conductive wire so as to have the same size and length. The windings 38B and 39B are wound so as to pass through respective paths which are inverted to each other with respect to the axial direction.

In a method for manufacturing the core 11F, a change in the rotation angle in each of the first and second stations S1E and S2E differs from that in the method according to the fifth modification. More specifically, as shown in FIG. 38, the apparatus M4 rotates counterclockwise the set of die 63E and punch paired with the die 63B by a predetermined rotational angle in the first station S1E every press blanking cycle such that the total rotation angle of holders satisfies the relationship shown in FIG. 41A. Further, the apparatus M4 rotates clockwise the set of die 65B and punch paired with the die 65B by the predetermined rotational angle in the second station S2E every press blanking cycle such that the total rotation angle of holders satisfies the relationship shown in FIG. 41B.

Accordingly, the laminated stator core 11F can be efficiently manufactured at low cost such that the teeth 35B to 37B of the core 11F have side walls curved in a sine wave.

Further, because the windings are wound on walls curved in a sine wave, the magnetic flux induced in a motor using the core 11F is changed in a sine wave shape. Accordingly, torque ripple and cogging torque caused in the motor can be reduced.

Moreover, because each of the windings 38B and 39B is wound on each tooth of the core 11F along a direction inclined with respect to the axial direction, the length of each winding can be shortened, and copper loss in the windings can be reduced.

Furthermore, because the windings are wound on walls curved in a sine wave, the windings can be smoothly curved. Accordingly, damage caused to the winding during manufacture can be reduced.

### Other Modifications

In the embodiments and modifications, each of the teeth 13, 13A, 13B, 35A, 37A, 35B, 37B, 42A, 44A, 42B and 44B are formed in two press blanking operations. However, each tooth may be formed in three press blanking operations or more.

Further, the servomotor 61 is used in a station rotation mechanism to rotate each of the first stations S1, SiC and S1E. However, any rotation mechanism using hydraulic equipment, pneumatic pressure equipment or the like can be used as a station rotation mechanism. Moreover, the station rotation mechanism using gears is adopted. However, the station rotation mechanism may use a belt or a chain to transmit a rotational force generated in the motor 61 to the holders 53 and 54. Because the rotation mechanism with a belt or a chain can be manufactured in a simple structure, the rotating mechanism can rotationally move the first station S1 at high speed with high precision. Further, because of the rotation mechanism with a belt or a chain, a degree of freedom in disposing the first station and the motor 61 can be heightened, so that a core manufacturing apparatus can be obtained in a smaller size.

Furthermore, the station rotation mechanism is attached to the base 56 of the die holder 53 in the first station. However, the mechanism may be attached to the punch holder 54. Alternatively, the mechanism may be attached to both the holders 53 and 54. To independently rotate the holders 53 and 54′ a guide pin may be used to keep a relative positional relationship between the holders 53 and 54 in the horizontal plane. Further, the station rotation mechanism may directly rotate the set of die 63 and punch 64 while keeping a relative positional relationship between the die 63 and the punch 64 in the horizontal plane.

Still further, in place of the station rotation mechanism, a translation motion mechanism may be used to move the first station straight or linearly.

Still further, in the embodiments and modifications, the magnetic pole teeth exist in the whole area of the laminated stator core along the axial direction so as to equalize the length of each tooth in the axial direction with that of the core. However, a laminated stator core may be manufactured so as to form a non-tooth space on each end of the core in the axial direction. In each of the spaces, there are no teeth. In this case, the windings can be wound on the core without protruding from any of the ends of the core. Therefore, a stator having no coil end can be obtained, and a small-sized motor can be manufactured.

Still further, the core is shaped so as to dispose a rotor in a center hollow of the core. That is, the core is applied for an inner-rotor structure type motor. However, the core may be applied for an outer-rotor structure type motor wherein the core is disposed in an inner space of the motor, while a rotor is disposed in an outer space of the motor.

Still further, method and apparatus for manufacturing a laminated core can be applied to manufacture a laminated rotor core.

Still further, the teeth in each core are disposed at equal intervals. However, the teeth may be disposed at various intervals.

Still further, the teeth in the core 11, 11A or 11B have the same shape along the circumferential direction. However, the teeth may be formed in different shapes along the circumferential direction. In this case, it is required to increase the number of movable stations.

Still further, each tooth portion is shaped symmetrically with respect to a center axis of the tooth portion along the radial direction. However, each tooth portion may be shaped asymmetrically with respect to a center axis of the tooth portion along the radial direction.

Still further, sides of each tooth portion determining a width of the tooth portion extend in straight lines. However, each of the sides may be curved or may be formed of a combination of straight line(s) and curved line(s). For example, each tooth portion may have a brim or collar at an inner circumferential side thereof.

Still further, the teeth in each core are disposed symmetrically with respect to a center axis or point of the core. However, the teeth in each core may be disposed asymmetrically with respect to a center axis or point of the core.

Still further, one stator core is formed only of a plurality of core pieces. However, a powder magnetic core may be used to form a part of a stator core having complicatedly-shaped magnetic teeth.

Still further, in the method and apparatus according to the embodiments, a laminate core used for a motor is manufactured. However, the embodiments should not be construed as limiting the present invention to a laminate core used for a motor. For example, the method and apparatus may be applied for a cooling member having through holes inside thereof or having fins on an outer circumferential surface thereof.

Still further, in the modifications 3 to 6, this method is applied for the four-pole type motor. However, this method can also be applied for a motor having a predetermined number of poles other than four.

What is claimed is:

1. A method for manufacturing a laminated core from a plurality of core pieces, comprising:
blanking out a first portion of a steel plate every blanking cycle to form a first hole of one core piece in the steel plate every blanking cycle;
blanking out a second portion of the steel plate every blanking cycle to form a second hole of one core piece in the steel plate every blanking cycle;
producing the core pieces from the steel plate in a plurality of blanking cycles; and
piling up the produced core pieces in layers to manufacture the laminated core,
wherein the step of blanking out the first portion includes:
partly shaping a portion of each core piece by forming the first hole of the core piece; and
differentiating a position of the first hole in a particular core piece among the core pieces from positions of the first holes in the other core pieces, and
the step of blanking out the second portion includes:
partly shaping the portion of each core piece by forming the second hole of the core piece to shape the portion of the core piece by forming the first and second holes.

2. The method according to claim 1, wherein the step of differentiating the position of the first hole includes:
shifting the position of the first hole in the particular core piece by a predetermined rotation angle along a circumferential direction of the particular core piece.

3. The method according to claim 1, wherein the step of piling up the produced core pieces includes:
rotating the particular core piece by a predetermined angle along a circumferential direction of the particular core piece.

4. The method according to claim 1, wherein the step of blanking out the second portion of the steel plate includes:
placing the second hole in each core piece at a fixed position of the core piece.

5. The method according to claim 1, wherein the step of blanking out the second portion of the steel plate includes:
differentiating a position of the second hole in the particular core piece from positions of the second holes in the other core pieces.

6. The method according to claim 1, wherein the step of differentiating the position of the first hole includes:
differentiating positions of the first holes in the respective core pieces from one another, and
the step of blanking out the second portion of the steel plate includes:
placing the second hole in each core piece at the same position as those of the second holes in the other core pieces.

7. The method according to claim 1, wherein the step of differentiating the position of the first hole includes:
differentiating positions of the first holes in the respective core pieces from one another, and
the step of blanking out the second portion of the steel plate includes:
differentiating positions of the second holes in the respective core pieces from one another.

8. The method according to claim 1, wherein the step of partly shaping the portion of the core piece by forming the first hole includes:
partially shaping a magnetic pole tooth portion protruded into a center hollow of the core piece as the portion of the core piece,
the step of partly shaping the portion of the core piece by forming the second hole includes:
partially shaping the magnetic pole tooth portion to shape the magnetic pole tooth portion of the core piece by forming the first and second holes, and
the step of piling up the produced core pieces includes:
forming a magnetic pole tooth of the laminated core from the magnetic pole tooth portions of the core pieces piled up.

9. The method according to claim 1, wherein the step of differentiating the position of the first hole includes:
changing a position of the first hole in each core piece by a predetermined rotation angle along a circumferential direction of the core piece each time the first hole of the core piece is formed.

10. The method according to claim 9, wherein the step of blanking out the second portion of the steel plate includes:
placing the second hole in each core piece at a fixed position, and
the step of piling up the produced core pieces includes:
rotating the particular core piece by another predetermined angle along a direction opposite to the circumferential direction.

11. The method according to claim 1, wherein the step of piling up the produced core pieces includes:
forming a first wall on a portion of the laminated core from the portions of the core pieces partly shaped by forming the first holes;
forming a second wall on the portion of the laminated core from the portions of the core pieces partly shaped by forming the second holes; and
forming a third wall shaped by forming the first and second walls on the portion of the laminated stator.

12. The method according to claim 11, wherein the step of forming the third wall includes:
forming the third wall in a trapezoid.

13. The method according to claim 11, wherein the step of forming the first wall includes:
substantially forming the first wall curved in a sine wave, and
the step of forming the second wall includes:
substantially forming the second wall curved in the sine wave.

14. The method according to claim 11, wherein the step of forming the third wall includes:
substantially forming the third wall in an elliptical or circular shape.

15. The method according to claim 1, wherein the step of blanking out the first portion includes:
forming a third hole in one core piece in the steel plate every blanking cycle to partly shape a first portion of the core piece by forming the third hole and to partly shape a second portion of the core piece by forming the third hole,
the step of partly shaping the portion of the core piece by forming the first hole includes:
partly shaping the second portion of the core piece by forming the first hole; and
partly shaping a third portion of the core piece by forming the first hole,
the step of partly shaping the portion of the core piece by forming the second hole includes:
partly shaping the first portion of the core piece by forming the second hole; and
partly shaping the third portion of the core piece by forming the second hole, and
the step of piling up the produced core pieces includes:
forming a first portion of the laminated core from the first portions of the core pieces partly shaped by forming the second and third holes;
forming a second portion of the laminated core from the second portions of the core pieces partly shaped by forming the first and third holes; and
forming a third portion of the laminated core from the third portions of the core pieces partly shaped by forming the first and second holes.

16. The method according to claim 15, wherein the step of forming the first portion of the laminated core includes:
substantially forming the first portion in a frustum of pyramid so as to have a wall formed in a trapezoid, the step of forming the second portion of the laminated core includes:
substantially forming the second portion in a parallelepiped so as to have a wall formed in a parallelogram, and
the step of forming the third portion of the laminated core includes:
substantially forming the third portion in another frustum of pyramid inverted to that of the first portion with respect to a piling direction of the laminated core so as to have a wall formed in a trapezoid.

17. The method according to claim 15, wherein the step of forming the first portion of the laminated core includes:
forming the first portion almost in a frustum of pyramid so as to have a trapezoidal wall shaped by a sine wave line, the step of forming the second portion of the laminated core includes:
forming the second portion almost in a parallelepiped so as to have a parallelogram-shaped wall shaped by sine wave lines, and
the step of forming the third portion of the laminated core includes:
forming the third portion in another frustum of pyramid inverted to that of the first portion with respect to a piling direction of the laminated core so as to have a trapezoidal wall with edges shaped in a sine wave line.

18. The method according to claim 1, wherein the step of blanking out the first portion includes:
forming a third hole in one core piece in the steel plate every blanking cycle to partly shape a first portion of the core piece by forming the third hole and to partly shape a second portion of the core piece by forming the third hole,
the step of partly shaping the portion of the core piece by forming the first hole includes:
partly shaping the second portion of the core piece by forming the first hole; and
partly shaping a third portion of the core piece by forming the first hole,
the step of blanking out the second portion includes:
forming a fourth hole in one core piece in the steel plate every blanking cycle to partly shape the third portion of the core piece by forming the fourth hole and to partly shape a fourth portion of the core piece by forming the fourth hole,
the step of partly shaping the portion of the core piece by forming the second hole includes:
partly shaping the first portion of the core piece by forming the second hole; and
partly shaping the fourth portion of the core piece by forming the second hole, and
the step of piling up the produced core pieces includes:
forming a first portion of the laminated core from the first portions of the core pieces partly shaped by forming the second and third holes;
forming a second portion of the laminated core from the second portions of the core pieces partly shaped by forming the first and third holes;
forming a third portion of the laminated core from the third portions of the core pieces partly shaped by forming the first and fourth holes; and
forming a fourth portion of the laminated core from the fourth portions of the core pieces partly shaped by forming the second and fourth holes.

19. The method according to claim 18, wherein the step of forming the first portion of the laminated core includes:
substantially forming the first portion in a frustum of pyramid so as to have a wall formed in a trapezoid, the step of forming the second portion of the laminated core includes:
substantially forming the second portion in a parallelepiped so as to have a wall formed in a parallelogram,
the step of forming the third portion of the laminated core includes:
substantially forming the third portion in another frustum of pyramid inverted to that of the first portion with respect to a piling direction of the laminated core so as to have a wall formed in a trapezoid, and
the step of forming the fourth portion of the laminated core includes:
substantially forming the fourth portion in another parallelepiped inverted to that of the second portion with respect to the piling direction so as to have a wall formed in a parallelogram.

20. The method according to claim 18, wherein the step of forming the first portion of the laminated core includes:
forming the first portion almost in a frustum of pyramid so as to have a trapezoidal wall shaped by a sine wave line, the step of forming the second portion of the laminated core includes:
forming the second portion almost in a parallelepiped so as to have a parallelogram-shaped wall shaped by sine wave lines,
the step of forming the third portion of the laminated core includes:
forming the third portion in another frustum of pyramid inverted to that of the first portion with respect to a piling direction of the laminated core so as to have a trapezoidal wall shaped by a sine wave line, and
the step of forming the fourth portion of the laminated core includes:
forming the fourth portion in another parallelepiped inverted to that of the second portion with respect to a piling direction of the laminated core so as to have a parallelogram-shaped wall shaped by sine wave lines.

21. An apparatus for manufacturing a laminated core from a plurality of core pieces, comprising:
a first blanking station that blanks out a first portion of a steel plate every blanking cycle to form a first hole of one core piece in the steel plate every blanking cycle;
a second blanking station that blanks out a second portion of the steel plate every blanking cycle to form a second hole of one core piece in the steel plate every blanking cycle; and
a piling unit that produces the core pieces from the steel plate in a plurality of blanking cycles and piles up the core pieces in layers to manufacture the laminated core,
wherein the first blanking station is adapted to partly shape a portion of each core piece by forming the first hole of the core piece while differentiating a position of the first hole in a particular core piece among the core pieces from positions of the first holes in the other core pieces, and
wherein the second blanking station is adapted to partly shape the portion of each core piece by forming the second hole of the core piece such that the portion of the core piece is shaped by forming the first and second holes.

22. The apparatus according to claim 21, wherein the piling unit has a rotation member that rotates the particular core piece by a predetermined rotation angle along a circumferential direction of the particular core piece.

23. The apparatus according to claim 21, wherein the second blanking station is adapted to place the second hole in each core piece at a fixed position of the core piece.

24. The apparatus according to claim 21, wherein the second blanking station has a station moving mechanism that differentiates a position of the second hole in the particular core piece from positions of the second holes in the other core pieces.

25. The apparatus according to claim 21, wherein
the first blanking station is adapted to partially shape a magnetic pole tooth portion protruded into a center hollow of the core piece as the portion of the core piece,
the second blanking station is adapted to partially shape the magnetic pole tooth portion such that the magnetic pole tooth portion of the core piece is shaped by forming the first and second holes, and
the piling unit is adapted to form a magnetic pole tooth of the laminated core from the magnetic pole tooth portions of the core pieces piled up.

26. The apparatus according to claim 21, wherein the first blanking station has an upper die having a punch, a lower die having a die paired with the punch, and a guide post connecting the upper and lower dies so as to permit a relative motion of the upper and lower dies.

27. The apparatus according to claim 21, wherein the first blanking station has a station rotation mechanism that rotates the first blanking station relative to the steel plate so as to change a position of the first hole in each core piece by a predetermined rotation angle along a circumferential direction of the core piece each time the first hole of the core piece is formed.

28. The apparatus according to claim 21, wherein the station rotation mechanism has a gear such that a rotational force is transmitted from a rotational power source to the first blanking station through the gear.

29. The apparatus according to claim 21, wherein the station rotation mechanism has a belt such that a rotational force is transmitted from a rotational power source to the first blanking station through the belt.

30. The apparatus according to claim 21, wherein the station rotation mechanism has a chain such that a rotational force is transmitted from a rotational power source to the first blanking station through the chain.

31. A laminated core manufactured from a plurality of core pieces according to a manufacturing method, the method comprising:
blanking out a first portion of a steel plate every blanking cycle to form a first hole of one core piece in the steel plate every blanking cycle;
blanking out a second portion of the steel plate every blanking cycle to form a second hole of one core piece in the steel plate every blanking cycle;
producing the core pieces from the steel plate in a plurality of blanking cycles; and
piling up the produced core pieces in layers to manufacture a laminated core,
wherein the step of blanking out the first portion includes:
partly shaping a portion of each core piece by forming the first hole of the core piece; and
differentiating a position of the first hole in a particular core piece among the core pieces from positions of the first holes in the other core pieces, and
the step of blanking out the second portion includes:
partly shaping the portion of each core piece by forming the second hole of the core piece to shape the portion of the core piece by forming the first and second holes.
